(19) United States
(12) Patent Application Publication
(10) Pub. No.: US 2017/0166343 A1
(43) Pub. Date: Jun. 15, 2017

(54) SYSTEM FOR PROVIDING INFLATED CUSHIONS

(71) Applicant: Sealed Air Corporation (US), Duncan, SC (US)

(72) Inventors: Brian A. Murch, Needham, MA (US); Laurence B. Sperry, Newton, MA (US)

(21) Appl. No.: 15/190,474

(22) Filed: Jun. 23, 2016

Related U.S. Application Data
(60) Provisional application No. 62/188,171, filed on Jul. 2, 2015.

(51) Int. Cl. B65B 65/08; B31D 5/00; B65H 16/00; B65H 35/10; B65B 61/12; B65B 57/02

(52) U.S. Cl. CPC B65B 65/08; B65B 61/12; B65B 57/02; B65H 16/005; B65H 35/10; B31D 5/0073

(57) ABSTRACT

A system for providing a web of inflated containers includes a conveyance system, a detachment arm, and a controller. The conveyance system has an operative mode in which the web is advanced along a path of travel by counter-rotating members having a nip through which at least a portion of the web passes and (ii) an idle mode. The detachment arm is positioned beside the path of travel downstream from the conveyance system. The detachment arm has a separator end to engage the web in the path of travel. The controller is programmed to operatively control the conveyance system to move to: (i) the operative mode to advance the web by a predetermined number of containers and (ii) the idle mode in which a transverse detachment line of the web is aligned with the separator end of the detachment arm.

This application claims the benefit of U.S. Provisional Application No. 62/188,171 filed Jul. 2, 2015, which is incorporated herein in its entirety by reference.

The presently disclosed subject matter relates to a system for providing inflated packaging cushions, for example, a string of inflated containers for protective packaging.

### BACKGROUND

Inflated cushions, pillows, or other inflated containers may be used in packaging for dunnage, protective, and/or bracing functions. Automated machines may be used to manufacture a web or string of such inflated containers (i.e., cushions), for example, as described in U.S. Patent Application Publ. 2015/0075114 A1, which is incorporated herein in its entirety by reference. The string of cushions output from such machine may be stored in a bin or other container to provide an accumulation of cushions for the operator who is packaging articles for shipment. The operator may access the cushions directly from the bin, or a dispensing apparatus may be used to facilitate dispensing the string of cushions from the bin to the operator at a packaging station. Such dispensing apparatus is described, for example, in U.S. Pat. No. 8,554,363, which is incorporated herein in its entirety by reference.

While cushion manufacture systems incorporating a bin may provide some accumulation advantages for accommodating a supply of cushions during peak packaging demand, the use of an accumulation bin and related dispensing equipment may add to the cost, complexity, and space requirements for the system.

Further, regardless of whether a bin is used to store an accumulation of inflated cushions, the operator in some operations has to determine the number of cushions to provide in a string of cushions that are detached from the web for a selected package. This may result in miscounting or incorrectly estimating the number of cushions required for the selected package.

### SUMMARY

One or more embodiments of the presently disclosed subject matter may address one or more of the aforementioned problems. In an embodiment, a system may be useful to provide a web of inflated containers. The web has a transverse detachment line between the adjacent containers. The system includes a conveyance system, a detachment arm, and a controller. The conveyance system has (i) an operative mode in which the web is advanced along a path of travel by counter-rotating members having a nip through which at least a portion of the web passes and (ii) an idle mode in which the web is stationary. The detachment arm is positioned beside the path of travel downstream from the conveyance system. The detachment arm has a separator end to engage the web in the path of travel. The controller is programmed to operatively control the conveyance system to move to: (i) the operative mode to advance the web by a predetermined number of containers and (ii) the idle mode in which a transverse detachment line of the web is aligned with the separator end of the detachment arm.

Another embodiment is directed to a machine for separating a web of inflated containers. The web has a transverse detachment line between the adjacent containers. The machine includes a counter, a detachment arm, and a controller. The counter has a sensor to detect the passing of each container of the web along a path of travel and to transmit counter information based on the passing. The detachment arm is positioned beside the path of travel downstream from the counter. The detachment arm has a separator end to engage the web in the path of travel. The detachment arm is moveable between: (i) an engaged position in which the separator end is aligned with a transverse detachment line of the web in the path of travel and (ii) a disengaged position in which the separator end does not engage the web. The controller is programmed to receive the counter information and a predetermined number of containers information to operatively control the movement of the detachment arm in response to the counter information and the predetermined number of containers information.

These and other objects, advantages, and features of the presently disclosed subject matter will be more readily understood and appreciated by reference to the detailed description and the drawings.

### BRIEF DESCRIPTION OF THE DRAWINGS

FIG. 1 is a perspective view of a machine for inflating and sealing an inflatable web having a series of containers;

FIG. 2 is similar to FIG. 1, except that it illustrates the machine being used with a roll of an inflatable web to inflate and seal the containers included in the web;

FIG. 3 is a front elevational view of the machine shown in FIG. 1;

FIG. 4 is similar to FIG. 1, except that the blower cover has been removed to show the blower;

FIG. 5 is an elevational view of the machine, as taken from the opposite side as shown in FIG. 1 and with the backside cover removed to show the components inside of the main housing for the machine;

FIG. 6 is a partial elevational view, taken along line 6-6 in FIG. 2;

FIG. 7 is a plan view of the inflation system, web tracking sensor, and controller components of the machine as shown in FIG. 1;

FIG. 7A is a cross-sectional view taken along line 7A-7A in FIG. 7;

FIG. 8 is a partial plan view of the machine, taken along line 8-8 in FIG. 2 and with the web guide removed from the sealing roller;

FIG. 9 is a plan view similar to FIG. 8, showing the advancement of the web to a stopping point;

FIG. 10 is a representative perspective view of a system 310 for providing inflated containers having a detachment arm 312 is a first position;

FIG. 11 is a representative perspective view of the system 310 of FIG. 10, but having the detachment arm 312 in an extended second position;

FIG. 12 is a detailed perspective view of the detachment arm 312 of FIG. 10;

FIG. 13 is a representative partial perspective view of the system 310 of FIG. 10, but having a web of inflatable cushions installed and having a transverse detachment line 44 aligned with the separation end 316 of the detachment arm 312;

FIG. 14 is a representative partial side elevation view of the system of FIG. 13;

FIG. 15 is a representative detailed perspective view of the system of FIG. 14, but showing a detachment event occurring by having a detachment force applied by the separator end 316 to detach the web along transverse detachment line 44;

FIG. 16 is a representative partial side view of the detachment arm 312 of FIG. 10 in the normal position;

FIG. 17 is a representative partial side view of the detachment arm 312 of FIG. 10 in the detachment position;

FIG. 18 is a representative perspective view of an alternative detachment arm 412 and receptor 414 configuration having a flapper switch 318 in the normal position;

FIG. 19 is a representative perspective view of the detachment arm and receptor of FIG. 18, but having the flapper switch 318 in the triggered position;

FIG. 20 is a representative perspective view of an alternative detachment arm 512 and receptor 514;

FIG. 21 is a representative perspective view of an alternative detachment arm 612 and receptor 614;

FIG. 22 is a representative side elevation view of another system 410 for providing inflated cushions;

FIG. 23 is a representative perspective view of machine 710 for separating a web 26 of inflated containers;

FIG. 24 is a representative side elevation view of the machine of FIG. 23, but before the web 26 has been detached; and

FIG. 25 is a representative side elevation view of the machine of FIG. 24, but having the detachment arm in the engaged position and showing string of cushions detached from the web 26.

Various aspects of the subject matter disclosed herein are described with reference to the drawings. For purposes of simplicity, like numerals may be used to refer to like, similar, or corresponding elements of the various drawings. The drawings and detailed description are not intended to limit the claimed subject matter to the particular form disclosed. Rather, the intention is to cover all modifications, equivalents, and alternatives falling within the spirit and scope of the claimed subject matter.

### DETAILED DESCRIPTION

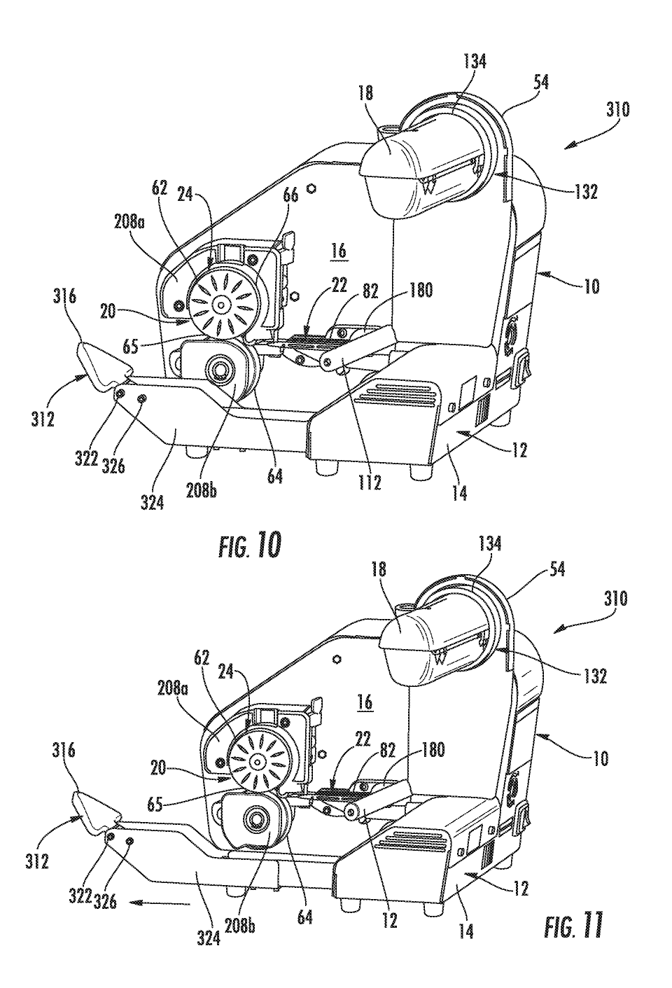

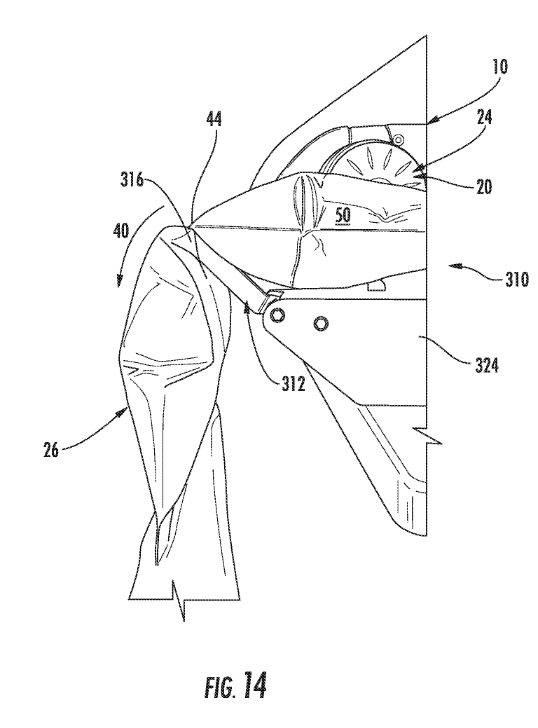

In one or more embodiments, a system (e.g., system 310 of FIGS. 10 and 13) for providing inflated containers 50 from a web 26 of inflatable containers 32 may include one of more of: (i) a machine (e.g., machine 10) for inflating and sealing an inflatable web, the machine including a conveyance system 20 and an inflation nozzle 82, (ii) a detachment arm (e.g., detachment arm 312), (iii) a receptor (e.g., receptor 314), and (iv) a controller (e.g., controller 94), as discussed herein in more detail.

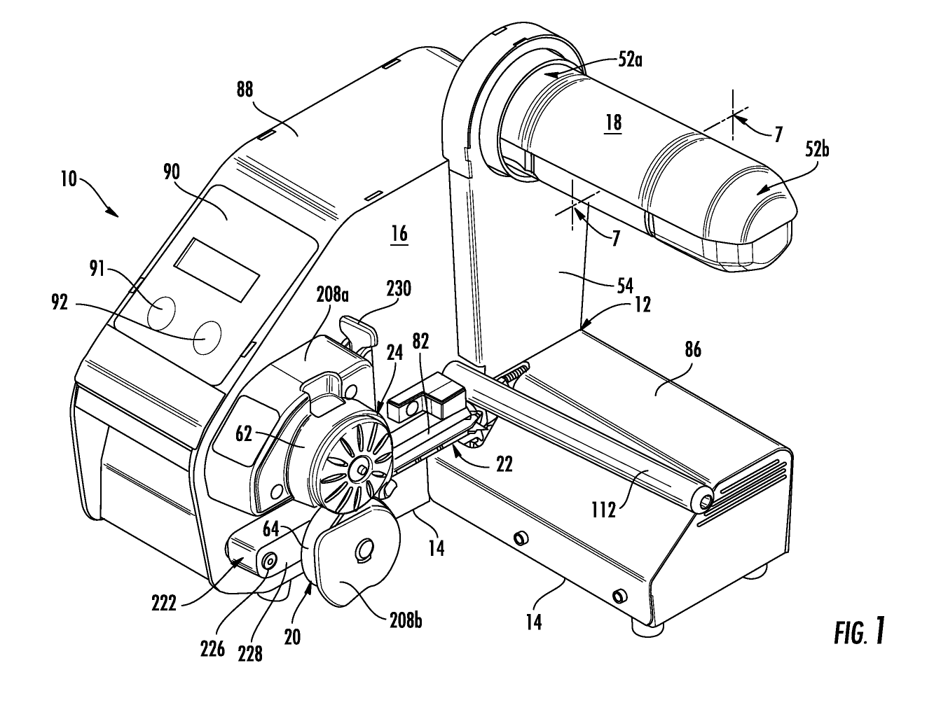

FIGS. 1 to 5 illustrate a machine 10 for inflating and sealing an inflatable web. Machine 10 includes a support structure 12, which may comprise a base 14 and a wall 16 extending upwards from the base. Machine 10 further includes a spool 18 for rotatively supporting a roll of the inflatable web, a web conveyance system 20 for conveying the inflatable web along a path of travel, an inflation system 22 for inflating the containers, and a sealing device 24 located proximate to the inflation system for sealing closed the inflated containers.

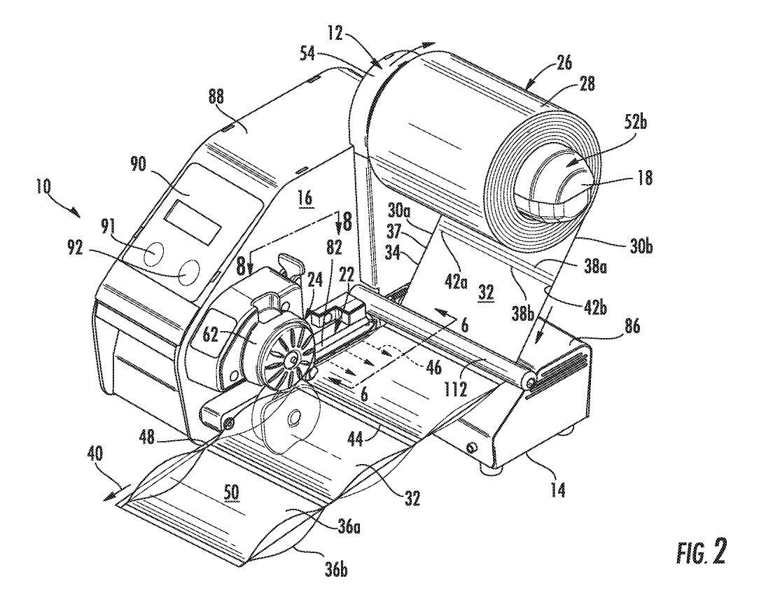

FIG. 2 illustrates machine 10 being used to inflate and seal an inflatable web 26. Web 26 may be in the form of a roll 28, which is rotatively supported by spool 18. Web 26 has opposing first and second longitudinal edges 30a, b, and includes a series of inflatable containers 32. Each of the containers 32 is capable of holding therein a quantity of gas (e.g., air) and each has an opening 34 at the first edge 30a for receiving such gas.

Web 26 may further comprise a pair of juxtaposed sheets 36a, b, e.g., film sheets. In the illustrated embodiment, first longitudinal edge 30a of the web 26 is open, i.e., unsealed, while second longitudinal edge 30b is closed (e.g., sealed or folded). The web conveyance system 20 conveys the inflatable web 26 along a path of travel 40, which is substantially parallel to the longitudinal edges 30a, b of the inflatable web.

The containers 32 may be defined between sheets 36a, b and between a series of transverse seals 38. The seals 38 are described as “transverse” because they are aligned in a direction that is generally transverse to the longitudinal edges 30a, b of web 26 and path of travel 40. Each container 32 may be separated by the adjacent container by one or more transverse seals 38. For example, each container may be separated by the adjacent container by one transverse seal 38, or each container 32 may be separated by two transverse seals 38, for example, by two transverse seals such as relatively closely-spaced pairs 38a, b, such that each container 32 is defined in web 26 between a leading transverse seal 38a from a downstream pair of seals 38, and a following transverse seal 38b from an adjacent, upstream pair of such seals. (FIG. 2.) Stated differently (i.e., from the perspective of the closely-spaced seal-pairs), the upstream transverse seal of each seal-pair is designated 38a while the downstream seal is designated 38b.

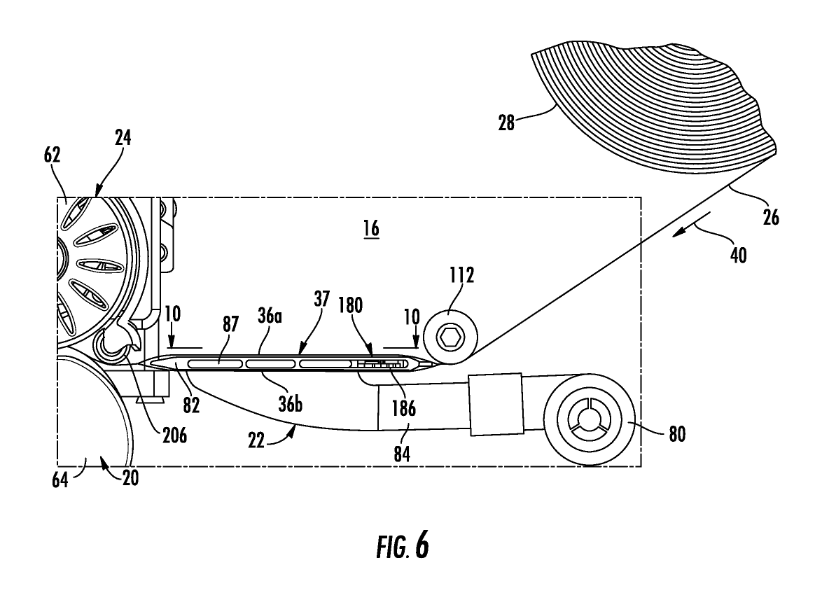

Each inflatable container has an inflation opening, for example, inflation opening 34. The openings 34 of the containers 32 may be formed by the open first edge 30a of the web 26 and the first ends 42a of the transverse seals 38. The opposing second ends 42b terminate at the closed second edge 30b. The first ends 42a of the transverse seals are spaced from first edge 30a, in order to form a pair of opposing open (unattached) flanges in sheets 36a, b that form an “open skirt” region 37, which allows inflation system 22 (e.g., nozzle 82 thereof), to be accommodated within web 26 (i.e., between film sheets 36a, b) in order to facilitate inflation. (FIG. 6.) See, also, for example U.S. Pat. No. 6,651,406, which is incorporated herein in its entirety by reference.

In order to allow individual or groups of inflated containers (i.e., a string of inflated cushions) to be separated from the web 26, a transverse detachment line 44 may extend across the web between each container 32. A detachment line is a region of relative weakness in the web material to facilitate separation of one container 32 from attachment to another container (e.g., to facilitate detachment of a string of inflated cushions from the remaining web). The facilitated separation may be, for example, manual separation by hand, or manual separation assisted by a detachment arm, as will be discussed in more detail herein. The transverse detachment line 44 (i.e., a region of relative weakness) may be in the form of a series of perforations in the web material (e.g., a perforated line), a scoring along the web material, or other configuration to cause relative weakness in the web material. In general, each transverse detachment line 44 will correspond to (e.g., be adjacent to or be formed within) at least one transverse seal 38 between adjacent containers 32. The detachment line 44 may be positioned, for example, between each upstream/downstream pair of transverse seals 38a, b as shown in FIG. 2. In view of this correspondence between a transverse detachment line 44 and a transverse seal 38, the locating of the one will provide location information of the other. That is to say, for example, that the use of a transverse tracking sensor (e.g., sensor 180) adapted to detect location information for a transverse seal 38 also inherently locates (i.e., detects location information) for the transverse detachment line 44 corresponding to the transverse seal. The transverse tracking sensor may also be said to be adapted to detect location information for the transverse detachment line by, for example, identifying the location of the apex of an inflated container 50 so that a computation may be made (e.g., by controller 94) to extrapolate to the location of the transverse detachment line 44 by, for example, adding to (or subtracting from) the apex location the known given distance from the apex to the transverse detachment line for the container.

Web 26 may, in general, comprise any flexible film material that can be manipulated by machine 10 to enclose a gas as herein described, including various thermoplastic materials (e.g., polyethylene homopolymer or copolymer, polypropylene homopolymer or copolymer). Non-limiting examples of suitable thermoplastic polymers include polyethylene homopolymers, such as low density polyethylene (LDPE) and high density polyethylene (HDPE), and polyethylene copolymers such as, for example, ionomers, ethylene/vinyl acetate copolymer (EVA), ethylene/methyl acrylate copolymer (EMA), heterogeneous (Zeigler-Natta catalyzed) ethylene/alpha-olefin copolymers, and homogeneous (e.g., metallocene, single-cite catalyzed) ethylene/alpha-olefin copolymers. Ethylene/alpha-olefin copolymers are copolymers of ethylene with one or more comonomers selected from C₃ to C₂₀ alpha-olefins, including linear low density polyethylene (LLDPE), linear medium density polyethylene (LMDPE), very low density polyethylene (VLDPE), and ultra-low density polyethylene (ULDPE). Various other polymeric materials may also be used such as, for example, polypropylene homopolymer or polypropylene copolymer (e.g., propylene/ethylene copolymer), polyesters, polystyrenes, polyamides, and polycarbonates. The film may be monolayer or multilayer and can be made by any known extrusion process by melting the component polymer(s) and extruding, coextruding, or extrusion-coating them through one or more flat or annular dies.

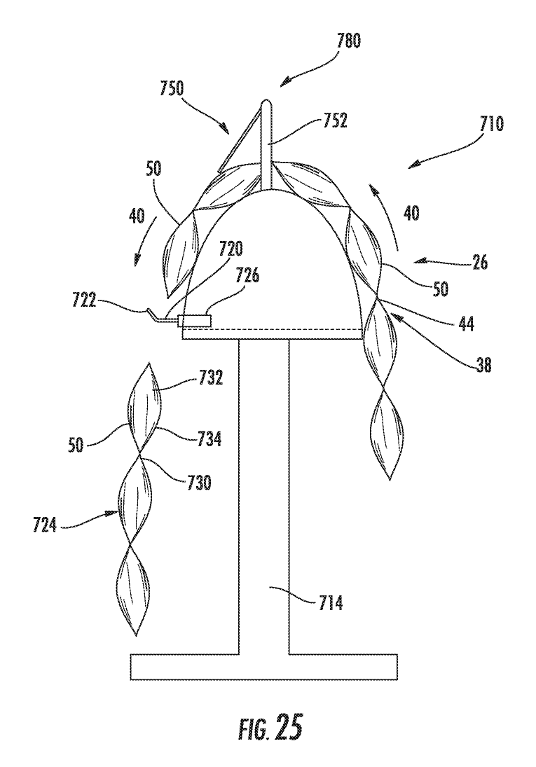

A conveyance system (e.g., web conveyance system 20) has (i) an operative mode in which the web 26 is advanced along the path of travel 40 by counter-rotating members having a nip through which at least a portion of the web passes and (ii) an idle mode in which the web 26 is stationary. For example, as shown in FIG. 2, web conveyance system 20 advances web 26 along path of travel 40 (for some duration beside wall 16), with the web being oriented such that the first edge 30a is adjacent to the wall. Inflation system 22 is positioned to direct gas, as indicated by arrows 46, into the openings 34 of the containers 32 as the web 26 is advanced along the path 40, thereby inflating the containers. A pair of convergent, counter-rotating rotary members (e.g., rollers 62, 64) may be positioned such that a nip 65 (i.e., an area of tangential contact) is formed therebetween for progressing the web by passing at least a portion of the web. Alternative ways of providing counter-rotating members to provide a nip of a conveyance system to progress or pass a web include opposing counter-rotating belts or tracks, for example, as illustrated in FIG. 22 (discussed in more detail below), and as described, for example in U.S. Pat. No. 8,978,345 and U.S. Patent App. Publ. 2010/0251668 A1, each of which is incorporated herein in its entirety by reference.

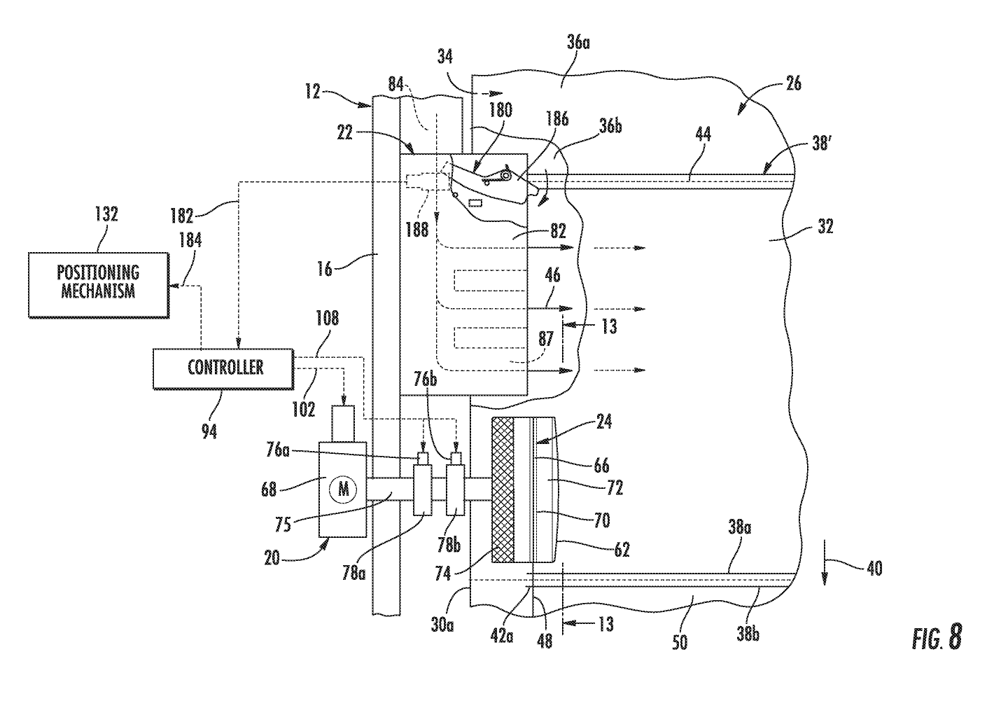

As also shown in FIG. 2, sealing device 24 may be positioned just downstream of the inflation system 22 so that it substantially contemporaneously seals closed the openings 34 of the containers 32 as they are being inflated (see, also, FIG. 8). Sealing device 24 may seal closed openings 34 by producing a longitudinal seal 48 between film sheets 36a, b, which also intersects transverse seals 38a, b near the first ends 42a thereof to enclose gas 46 within the containers 32. In this manner, the inflatable containers 32 of web 26 are converted into inflated containers 50 of web 26.

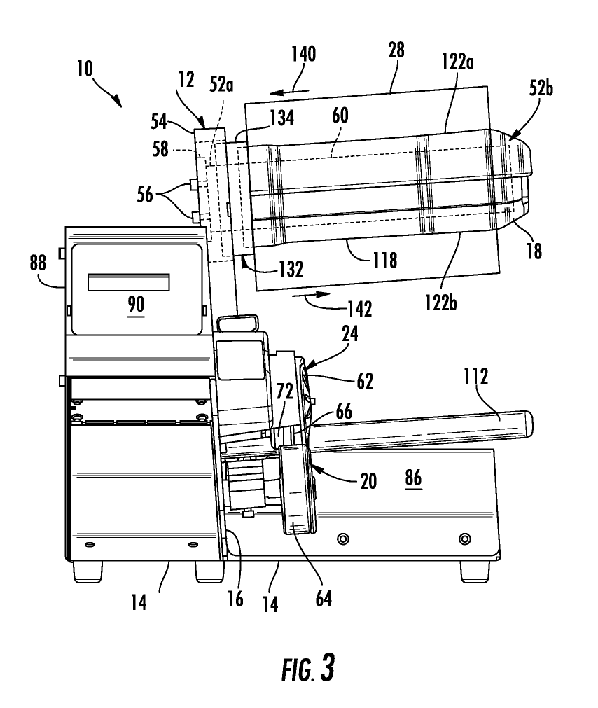

Referring to FIGS. 1 and 3, it may be seen that spool 18 has a proximal end 52a, at which the spool is attached to support structure 12, and may also have an opposing distal end 52b, which is spaced from the support structure. In the illustrated embodiment, for example, as perhaps best shown in FIG. 3, the distal end 52b may have a higher elevation relative to the proximal end 52a, that is, the spool 18 may have an upward angle (relative to a horizontal plane, e.g., to base 14) as the spool extends away from the wall 16. In this manner, when a web roll 28 is mounted thereon (shown in phantom in FIG. 3), the roll is gravitationally biased towards the support structure 12. Such upward angle of spool 18 may facilitate the manual act of loading a new web roll 28 onto the spool, as the upward angle is often more ergonomic for roll loading, and with gravity assisting in sliding the roll all the way onto the spool 18. The degree of elevation of the distal end 52b of spool 18 may be such that the upward angle of the spool relative to a horizontal plane is between about 1 to about 45 degrees, such as from about 2 to about 30 degrees, and from about 3 to about 20 degrees. As an example, an upward angle of about 4 degrees above horizontal was found to be suitable.

For those embodiments in which the spool 18 has an upwardly-angled configuration, the resultant gravitational bias of the roll 28 towards the support structure 12 urges the first longitudinal edge 30a of the web 26 towards the web conveyance system 20, inflation system 22, and sealing device 24. The gravitational bias of roll 28 towards support structure 12 has the potential, therefore, to facilitate the reliability of machine 10 by improving the tracking of the open edge of web through the inflation and sealing operations.

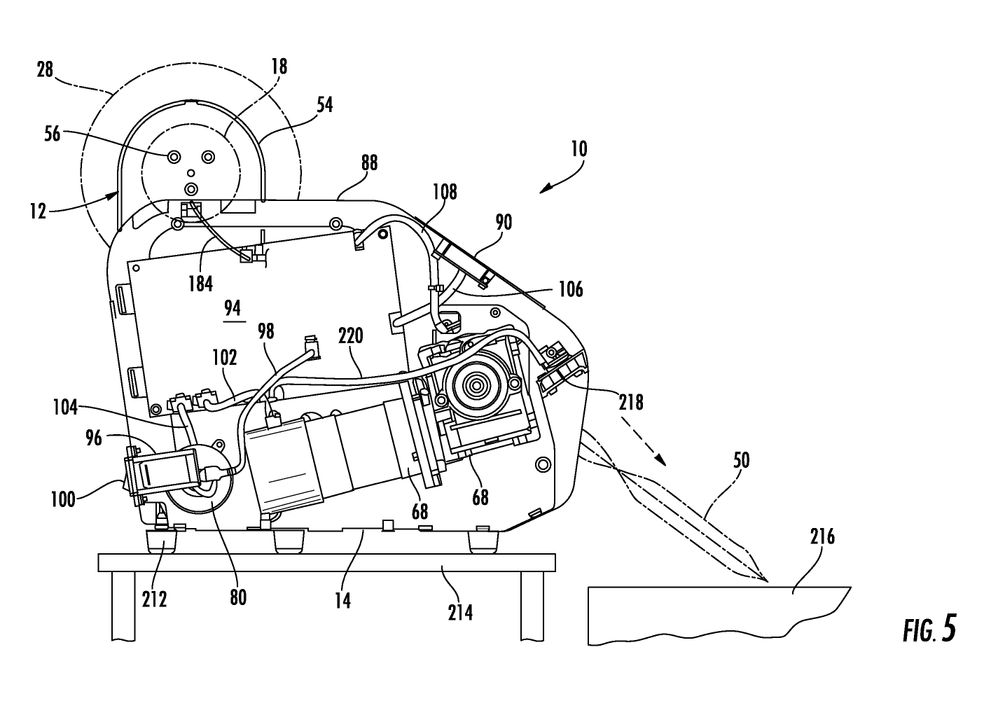

In order to accommodate the weight and diameter of a full roll 28, support structure 12 may include an upright structural bracket 54, to which spool 18 may be directly attached, for example, via fasteners (screws) 56 and mounting plate 58 as shown in FIG. 3 (see also FIG. 5, wherein a total of three such fasteners 56 are shown). Mounting plate 58 may thus form the attachment point at which the proximal end 52a of spool 18 is secured to support structure 12. Mounting plate 58 may be an integral part of an internal framework 60 for spool 18, to which the internal components thereof may be mounted. As shown, the upright bracket 54 may be secured to wall 16 of support structure 12, and may serve to elevate spool 18 such that there is sufficient space between the spool and base 14 to accommodate a roll 28 having a desired maximum, full-width diameter. The distal end 52b of the spool 18 may be unsupported (as illustrated) such that the spool is cantilevered from upright bracket 54 on wall 16. Alternatively (e.g., for large and/or heavy web rolls), the distal end 52b may be supported by a suitable structural component (e.g., an upstanding post with a cradle on which the distal end 52b rests) (not illustrated).

The upward angle of spool 18 may be achieved as shown in FIG. 3 by orienting wall 16, and also upright bracket 54, at an angle relative to a vertical plane, with spool 18 being substantially perpendicular to the wall. Alternatively, wall 16 (and also bracket 54) may be oriented in a substantially vertical plane, with spool 18 mounted on the wall (and/or on bracket 54) at an upward angle relative to a horizontal axis passing through the vertical plane. As a further alternative, spool 18 may not have an upward angle (i.e., may have a substantially horizontal configuration).

As noted above, sealing device 24 seals closed openings 34 of containers 32 by producing a longitudinal seal 48 between film sheets 36a, b, which intersects transverse seals 38a, b near the first ends 42a thereof to enclose gas 46 within the containers. In this manner, the inflatable containers 32 of web 26 are converted into inflated containers 50.

In some embodiments, the sealing device 24 and web conveyance system 20 may be incorporated together as an integrated assembly, which may include a pair of convergent, counter-rotating rotary member (e.g., rollers 62, 64), and a sealing element 66 secured to at least one of the rollers (e.g., to roller 62) as shown in FIG. 3. As previously mentioned, rollers 62, 64 may be positioned such that a nip 65 (i.e., an area of tangential contact) is formed therebetween. At least one of the rollers may be linked to a motor 68 (e.g., a motor and gearbox assembly 68 as shown in FIG. 5) such that when power is supplied to one or both rollers, the rollers rotate in opposing so that web 26 is advanced along path 40 when the web passes through the nip 65 between the rollers (FIG. 2). Simultaneous with such web conveyance, sealing element 66 forms longitudinal seal 48 at the nip between rollers 62, 64 to close the openings 34 of the inflated containers 32/50 as web 26 is advanced along path 40 (FIG. 8).

Sealing element 66 may be an electrically-heated resistive device, such as a band or wire, which generates heat when an electrical current passes through the device. sealing element 66 may be mounted on the circumferential outer surface 72 of roller 62, such that it rotates against the web 26 along with the roller 62. (FIG. 8.) When sealing element 66 is mounted on roller 62 as presently illustrated, roller 62 may be considered a “sealing roller” while roller 64 is considered a “backing roller.” When heated, the rotational contact between sealing element 66 and web 26, as rollers 62, 64 counter-rotate compressively against web 26, forms the longitudinal seal 48 as the web is conveyed along its path of travel 40.

In the illustrated embodiment, sealing element 66 is in the form of a wire. Sealing roller 62 may be formed from any material that is capable of withstanding the temperatures generated by the sealing element, such as metal (e.g., aluminum), high-temperature-resistant polymers (e.g., polyimide), ceramics, etc. A groove 70 may be provided in the circumferential outer surface 72 of roller 62 to accommodate sealing element 66 and keep it in proper position on the outer surface 72 during sealing and conveyance.

The outer surface 72 may include a roughened or knurled section 74 to facilitate traction between surface 72 and the web 26 in order to prevent or minimize slippage between the sealing roller 62 and the web as the roller rotates against the web to convey it along path 40. Web traction between rollers 62, 64 may further be facilitated by forming backing roller 64 from a pliant material, such as rubber or RTV silicone.

As illustrated in FIGS. 1 to 5 and 8, web conveyance system 20 may include rollers 62, 64, motor 68, and drive shaft 75, which extends through wall 16 to couple the rotational output of motor 68 to sealing roller 62. In this arrangement, sealing roller 62 is directly driven by motor 68 via drive shaft 75, while backing roller 64 is indirectly driven by the motor, based on its rotational contact with the driven roller 62. Sealing device 24 may, in addition to sealing element 66 and groove 70 on outer surface 72 of sealing roller 62, include commutators 76a, b (e.g., carbon-brush commutators) and corresponding slip-rings 78a, b (FIG. 8) in order to supply electricity to the sealing element 66 via internal wiring within drive shaft 75 and sealing roller 62. Further details regarding the above-described integrated web conveyance system 20 and sealing device 24 are disclosed in U.S. Pat. No. 7,225,599, the entire disclosure of which is hereby incorporated herein by reference thereto.

As shown in FIGS. 2 and 8, longitudinal seal 48 is oriented in a direction that is substantially parallel to the longitudinal edges 30a, b of web 26 and its direction of movement along its travel path 40 through machine 10. Seal 48 may, as shown, be a continuous longitudinal seal (i.e., a substantially linear, unbroken seal), which is interrupted only when the sealing device 24 is caused to stop making the seal.

Alternatively, sealing device 24 may be adapted to produce longitudinal seal 48 as a discontinuous series of longitudinal seal segments. A discontinuous series of longitudinal seal segments may be produced when sealing element 66 has a helical pattern on surface 72 of sealing roller 62 (or 64), resulting in an angled configuration of the longitudinal seal segments, (e.g., as disclosed in the above-incorporated '599 patent). As a further alternative, sealing element 66 may be arranged on sealing roller 62 as an overlapping helical pattern, e.g., as a “double helix,” as disclosed in U.S. Patent App. Publ. 2008-0250753 A1, which is incorporated herein in its entirety by reference.

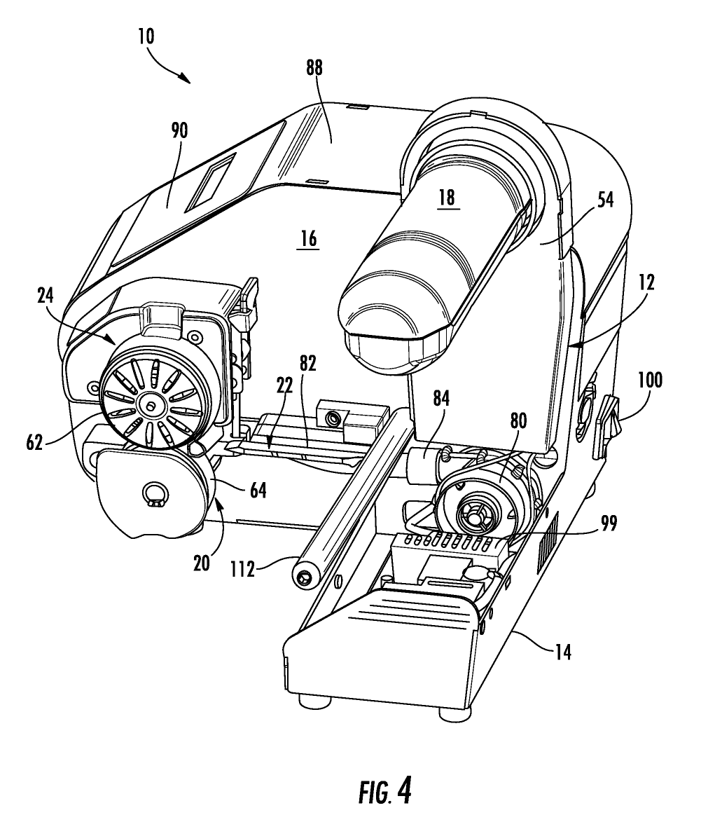

Gas stream 46 may comprise air. In this instance, inflation system 22 may include a blower 80 (FIGS. 4-6) for generating such gas stream 46 from the ambient air, an inflation nozzle 82, and a gas duct 84 to direct gas 46 from blower 80 to nozzle 82. In FIG. 4, blower cover 86 has been removed to show that blower 80 may be positioned on base 14 proximate nozzle 82 for maximum air delivery (i.e., minimum pressure loss) and speed. Nozzle 82 may be secured in position to direct gas (e.g., air) 46 into the openings 34 of the containers 32 via direct or indirect attachment to wall 16 and/or base 14. In the illustrated embodiment, nozzle 82 is attached to duct 84, and is further supported via attachment to wall 16.

FIG. 6 shows the conveyance of inflatable web 26 through inflation system 22, including the separation of film sheets 36a, b at open skirt region 37 to move against/around opposing surfaces of the inflation nozzle 82. FIG. 6 also shows that inflation nozzle may have a relatively flat/planar configuration, and may contain one or more gas outlets 87 (e.g., three such outlets as shown). Inflation nozzle 82 is adapted to direct gas into the inflatable containers 32 as the web 26 advances along the path of travel 40.

Machine 10 may include a housing 88, for example, on the opposite side of wall 16 from that with which the web-handling components (i.e., spool 18, inflation system 22, rollers 62, 64, etc.) are associated. The housing 88 may contain therein various operational devices, some of which are described above (e.g., motor 68), and some of which will be described below. Housing 88 may also contain thereon an operator interface (e.g., a control panel 90), which may include, at a minimum, a start button or switch 91 and a stop button or switch 92, which allows the operator of machine 10 to cause the machine to start operations and stop operations, respectively.

The systems and machines described herein (e.g., machine 10) may include a controller 94 to control the overall operation. The controller may be contained within housing 88 as shown in FIG. 5. Controller 94 may be in operative communication with the various sub-assemblies of machine 10, for example, to control the flow of power (e.g., electricity) thereto. Such control may take place indirectly, for example, by controlling the flow of power to the sub-assemblies from a separate power management source (not shown), or, as illustrated, directly. Thus, power may be supplied to controller 94 from junction box 96 via electrical cable 98. Junction box 96 may be supplied with power via a separate power cable (not shown), which connects the junction box to a power supply, e.g., a plug-in wall receptacle (not shown), which is linked to a source of electricity, and may include an “on-off” switch 100, to energize and de-energize, respectively, controller 94. In one example, when the source of electricity is alternating current, e.g., 110 or 220 volt AC, a transformer 99 may be included in machine 10 (FIG. 4) to convert such AC current into DC current (e.g., 24 volt DC), prior to such current being supplied to controller 94 via cable 98.

Various additional electrical cables (e.g., insulated wires) may be provided to allow controller 94 to electrically communicate with the sub-assemblies in machine 10 in order to control the operations thereof. Thus, cable 102 may be supplied to allow controller 94 to communicate with motor 68, i.e., to control the web conveyance system 20 in order to achieve, e.g., a desired rate of web conveyance, a desired stoppage point, a desired re-start, etc. Similarly, cable 104 may allow controller 94 to communicate with blower 80, e.g., to energize/de-energize the blower, control the rate of movement of gas 46, etc. Cable 106 may provide communication between control panel 90 and controller 94, e.g., in order to allow an operator to supply commands, e.g., “stop” and “start” commands, to the controller. Cable 108 may provide communication between controller 94 and commutators 76a, b, i.e., to control the sealing device 24 by, e.g., energizing/de-energizing sealing element 66, controlling the amount of power supplied thereto, etc. Further sub-assembly control links are described below.

With reference to FIGS. 2 and 6, a further feature of some embodiments of the disclosed subject matter are described. When web 26 is in the form of a roll 28 as shown, the force required to withdraw the web from the roll by web conveyance system 20 may change as the roll is depleted, such that the tension in web 26 may vary as the roll depletes. Such variation in web tension can contribute to mis-alignment of the web vis-à-vis the inflation system 22 and sealing device 24. Such mis-alignment, in turn, can result in a number of inflation and/or sealing problems, including non-inflation of the containers, under-inflation of the containers, and seal failures, i.e., incomplete or no sealing of those containers that are inflated (resulting in the deflation of such containers). Accordingly, machine 10 may further include one or more tension-control devices for controlling the tension in web 26 as it is conveyed along path 40 through the machine. Such devices may operate by applying frictional resistance to the web 26 in opposition to the advancement thereof by conveyance system 20.

One such device is illustrated in FIG. 6, wherein, as shown, a tension rod 112 may be positioned between roll 28 and inflation system 22, and may be structured and arranged to be in contact, e.g., sliding contact, with web 26 as it is conveyed along path 40. The sliding contact between tension rod 112 and web 26 provides frictional resistance to the web in opposition to its advancement along path 40. The magnitude of such frictional resistance is directly proportional to the extent of the contact between the web 26 and rod 112. In the illustrated arrangement, as the diameter of roll 28 decreases with depletion of its supply of web 26, the area of contact between web 26 and rod 112 increases, based on the increased angle of approach of the web onto the tension rod from roll 28. Conveniently, the tension rod 112 may also provide the function of a guide rod, in that it directs the web 26 into proper position on inflation nozzle 82. The tension rod 112 may have a substantially round or oval cross-sectional shape as shown. Various other shapes are, of course, possible, and within the scope of the present invention, e.g., square, rectangular, triangular, etc.

Other such tension-control devices are described, for example, in U.S. Patent Application Publication 2015/0075114 A1, which is incorporated herein in its entirety by reference. Spool 18 may for example be rotatably mounted to the wall 16/upright bracket 54 such that the roll 28 rotates with the spool as the spool rotates relative to the wall/bracket.

Machine 10 may include a positioning mechanism 132, which is structured and arranged to establish a position of the roll 28 on spool 18. (FIG. 3.) The positioning mechanism 132 may generally comprise an engagement member 134 and an actuator (not illustrated) which may be positioned internally in the spool 18. Positioning mechanisms are described, for example, in U.S. Patent Application Publication 2015/0075114 A1, which has previously been incorporated herein by reference.

As shown in FIG. 3, engagement member 134 is interposed between the roll 28 and support structure 12 (upright bracket 54 thereof) at the proximal end 52a of spool 18. Engagement member 134 is adapted to engage roll 28, and is structured and arranged to be movable relative to spool 18. For those embodiments in which the distal end 52b of spool 18 has a higher elevation relative to the proximal end 52a, spool 18 has an upward angle (relative to a horizontal plane) as the spool extends away from upright bracket 54. In such embodiments, web roll 28 is gravitationally biased towards bracket 54 of support structure 12, as indicated by arrow 140, which represents the force vector of the gravitational bias that acts on roll 28 as mounted on angled spool 18. Based on the interposition of engagement member 134 between roll 28 and upright bracket 54, such gravitational bias 140 results in roll 28 being forced against the engagement member (i.e., by gravity).

Machine 10 may include a web tracking sensor 180, which is adapted to detect a transverse position of the inflatable web 26, for example, with respect to inflation device 22 (FIG. 6). Information from the web tracking sensor 180 may be used to control the operation of the positioning mechanism 132 in order to establish a desired position of roll 28 on spool 18, to thereby maintain the transverse position of web 26 within a predetermined range for optimum alignment with inflation system 22 and sealing device 24.

In some embodiments, the web tracking sensor 180 may be structured and arranged to detect the transverse position of the web 26 by detecting the position of the open longitudinal edge 30a and/or the position of printed marks on the web, e.g., via a mechanical contact sensor, an optical sensor, an ultrasonic sensor, etc.

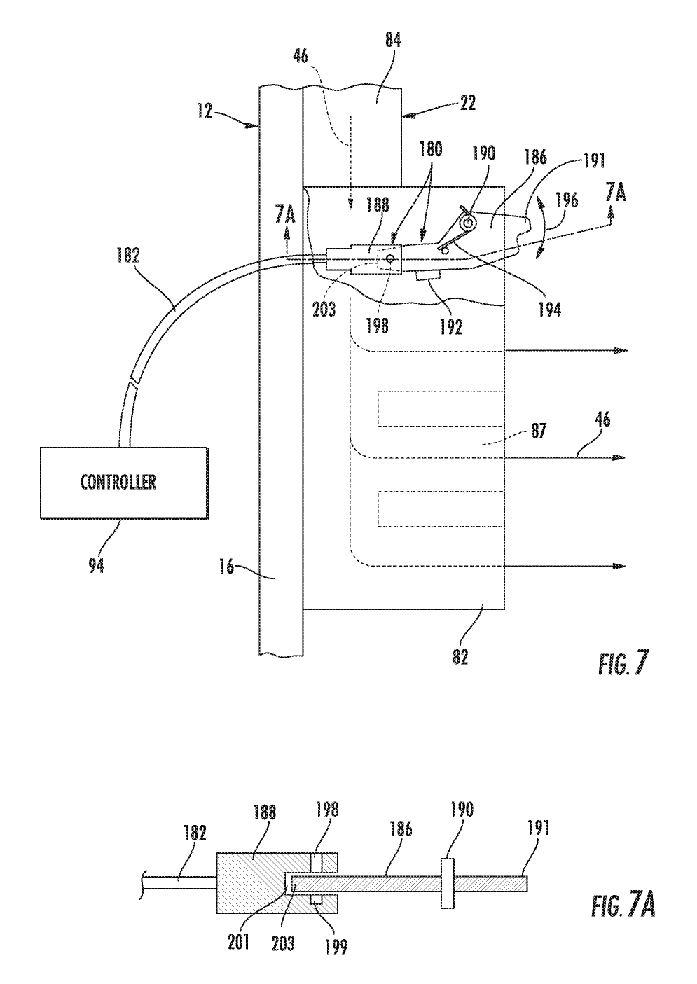

The systems of various embodiments of the disclosed subject matter may include a transverse tracking sensor adapted to detect location information for the transverse detachment lines 44 of the web 26. For example, the tracking sensor 180 may be structured and arranged to detect the transverse seals 38 (e.g., ends 42a or 42b thereof), such that a position of the transverse seals and/or the ends thereof indicates the transverse position of the transverse seal of web 26 and—because of the proximity of the transverse detachment line 44 to the transverse seal 38 as previously discussed—provide location information for the transverse detachment line 44. Such location information may be provided to the controller 94. For example, in the embodiment illustrated in FIGS. 7-8, the tracking sensor 180 is structured and arranged to detect first ends 42a of the transverse seals 38 via physical contact, such that the position of such first ends 42a indicates the location position of the transverse seal 38 and thus the corresponding transverse detachment line 44 of the web 26.

A transverse tracking sensor may include one or more of a mechanical sensor (i.e., using physical contact as described above), an optical sensor, an ultrasonic sensor, a magnetic sensor, a force sensor (e.g., a force-sensitive resistor and the like), and an accelerometer. For example, transverse seal ends 42a may be detected optically, for example, via an optical sensor adapted to optically detect such seal ends of the transverse seals 38.

Controller 94 may be in operative communication with one or more of web tracking sensor 180 (e.g., via input cable 182 of FIG. 7) and with positioning mechanism 132 (e.g., via output cable 184 of FIGS. 5 and 8). Controller 94 may further be adapted, e.g., programmed, to receive input 182 from tracking sensor 180 and, based on that input, send output 184 to positioning mechanism 132 to adjust the position of roll 28 on spool 18 so as to maintain the transverse position of the inflatable web 26 within a predetermined range, for example so that the first ends 42a of transverse seals 38 are neither too close nor too far away from tracking sensor 180, and thus in good alignment with inflation system 22 and sealing device 24 for proper inflation and sealing.

In the illustrated embodiment, tracking sensor 180 may be structured and arranged to be contacted by the first ends 42a of transverse seals 38. Tracking sensor 180 may thus comprise a contact sensor 186 and a detection sensor 188. Contact sensor 186 may be adapted to make physical contact with transverse seals 38 without impeding the movement of the web 26 along path 40. The contact sensor 186 may thus be movable (e.g., pivotable, translatable, bendable) so that it moves upon contact with the transverse seals 38. In the illustrated embodiment, contact sensor 186 is pivotally mounted inside of inflation nozzle 82 at pivot point 190, with a contact portion 191 extending from nozzle 82 so as to make contact with transverse seals 38 in sequential fashion as web 26 is conveyed past the inflation nozzle. Contact portion 191 thus resides inside of web 26 during inflation and sealing operations, i.e., between sheets 36a, b at the openings 34 of the containers 32. Contact sensor 186 may be biased against pivot stop 192 by coil spring 194, and is thus pivotally movable along arcuate arrow 196 (FIG. 7).

The movement of contact sensor 186 serves two functions. First, by moving upon contact with the seals 38, the contact sensor 186 allows the web 26 to continue its conveyance along path 40 (FIG. 8). Preferably the movement is such that web conveyance continues without significant deviation due to the contact with the sensor. Secondly, the movement of the contact sensor 186 allows detection thereof by the detection sensor 188 in such a way that the transverse position of web 26 may be determined. The detection sensor 188 may, for example, be an optical sensor, including a light emitter 198 and a light receptor 199 (FIG. 7A), wherein light emitter 198 produces a beam of light, which is detect by light receptor 199, with emitter 198 and receptor 199 being spaced apart by gap 201. The contact sensor 186 and detection sensor 188 may be relatively arranged as shown in FIG. 7A, such that a tail portion 203 of contact sensor 186 is pivotally movable through gap 201 in detection sensor 188 as contact sensor 186 pivots about pivot point 190 through arc 196. Further, when the contact sensor 186 is in a neutral or resting position as shown in FIG. 7, i.e., with spring 194 urging the sensor against pivot stop 192 due to no contact between contact portion 191 and transverse seals 38, the tail portion 203 is positioned inside of detection sensor 188 such that the tail portion is interposed between light emitter 198 and light receptor 199, whereby the tail portion 203 prevents the light beam produced by emitter 198 from reaching receptor 199. In this position, the tail portion 203 may be said to “break” such light beam, such that no light is detected by receptor 199. The detection sensor 188 may thus be configured to send signal 182 to controller 94 only when, and for so long as, light is detected by receptor 199, whereby such signal 182 is indicative of both the fact and duration of contact between transverse seals 38 and contact portion 191 of contact sensor 186.

In the illustrated embodiment, the incidence and duration of light detection by receptor 199, i.e., based on the movement of contact sensor 186 due to contact with transverse seals 38, provides an indication of the transverse position of web 26. Thus, for example, if no light is detected, this means that the ends 42a of transverse seals 38 are not making contact with contact sensor 186 because the ends 42a, and therefore web 26, are too far away from inflation system 22 and sealing device 24 for proper inflation and sealing of the web 26. In this case, controller 94 sends a command output 184 to positioning mechanism 132, to move the roll 26 on spool 18 in the direction of arrow 178, i.e., towards mounting plate 58/support member 12, which causes web 26, and thus ends 42a of transverse seals 38, to move closer to inflation system 22 and sealing device 24.

In contrast, if periodic contact is made between the contact sensor 186 and ends 42a of the transverse seals, but the corresponding periodic duration of light detection by receptor 199 is above a predetermined value, this is an indication that the web 26 (transverse seals 38 thereof) are too close to inflation system 22 and sealing device 24. In such condition, the ends 42a of the transverse seals hold the contact sensor 186 pivotally away from its neutral/beam-breaking position (FIG. 7) for a duration of time that is greater than when the ends 42a are farther away from the sensor. The proper duration of light detection for correct positioning of the ends 42a, representing optimal alignment of web 26 for inflation and sealing, can be readily determined, e.g., empirically, by those having ordinary skill in the art of making and/or using inflation and sealing machines without undue experimentation. Once this value is determined, it can be programmed into controller 94. Thus, when a light detection duration occurs that exceeds the predetermined/pre-programmed value, controller 94 will send a command output 184 to positioning mechanism 132 to move the roll 26 away from mounting plate 58/support member 12. This causes web 26, and thus ends 42a of transverse seals 38, to move away from contact sensor 186, inflation system 22, and sealing device 24.

As a further example, light may be detected by receptor 199 in intervals, indicating periodic contact between transverse seals 38 and contact sensor 186, but the duration of each period of light detection may be below the predetermined/pre-programmed value as described above. In this case, the web 26 is not so far away from inflation system 22 that the transverse seal ends 42a fail to make contact with contact sensor 186, but the web is still too far away for optimal alignment as indicated by the contact sensor 186 being held pivotally away from its neutral/beam-breaking position (FIG. 7) for a duration of time that is less than desired for a proper spatial relationship between the contact sensor 186 and the transverse seal ends 42a. In this case, like the “no-contact” scenario described above, controller 94 sends a command output 184 to positioning mechanism 132, to move the roll 26 on spool 18 to cause web 26 to move closer to inflation system 22 and sealing device 24.

In a typical case, the transverse position of inflatable web 26 will oscillate within a range, centered on the predetermined/pre-programmed value for the periodic duration of light detection by receptor 199, which corresponds to the selected spatial relationship between the contact sensor 186 and the transverse seal ends 42a. Such predetermined range may be as narrow or wide as desired, e.g., depending on how controller 94 is programmed to run the resultant feed-back control loop. In this regard, various modes of control may be employed by controller 94, including proportional, derivative, integral, and combinations thereof, e.g., PID (proportional-integral-derivative) control, to achieve a desired predetermined range within which the transverse position of web 26 oscillates.

Controller 94 may comprise one or more of a microprocessor; a central processing unit (CPU); an integrated circuit; memory; computer programming code; printed circuit assembly, e.g., a printed circuit board (PCB), and include a control unit, e.g., an electronic controller, such as a microcontroller, which stores pre-programmed operating codes; programmable logic controller (PLC); programmable automation controller (PAC); a personal computer (PC); or other such control device which is capable of receiving both operator commands and electronic, sensor-generated inputs, and carrying out predetermined, e.g., pre-programmed, operations based on such commands and inputs. Programming commands may be supplied to the controller 94 via control panel 90 or other type of operator interface, e.g., a wireless communication device.

Controller 94 may further be adapted, e.g., programmed, to determine the length of the containers 32 in any given inflatable web used with machine 10. With respect to the illustrated web 26, for example, the “length” of the container 32 is the longitudinal distance between a leading transverse seal 38a from a downstream pair of seals 38 and a following transverse seal 38b from an adjacent, upstream pair of seals 38, i.e., as measured parallel to the longitudinal edges 30a, b. The container length may be determined by controller 94 based on the rate at which web 26 is conveyed along path 40 by conveyance system 20, and upon the duration of the beam-break periods in web tracking sensor 180, in which the contact sensor 186 moves between transverse seals 38a, b within a container 32, and is thus in its neutral/non-contact position as shown in FIG. 7. The rate of web conveyance is a value that is stored in, i.e., “known by”, controller 94, e.g., based on operator input via control panel 90 (and thus the basis of output 102 from controller 94 to conveyance system 20).

The ability to determine container-length is advantageous, in that it allows the operations of selected sub-assemblies of machine 10 to be customized, based on the determined container-length in the web that is in use as the determination is made, in order to optimize the inflation and sealing of the containers in such web. For example, smaller containers often benefit from higher inflation rates vs. larger containers, and thus the speed of blower 80 may be varied based on the detected container-length.

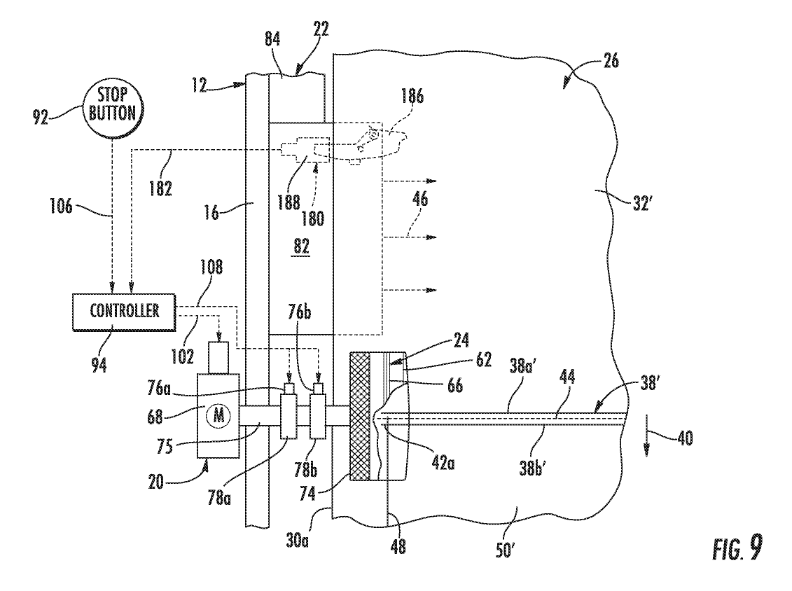

A related feature will be described with respect to FIG. 9, wherein controller 94 may further be adapted, e.g., programmed, to cause machine 10 to discontinue operations in such a manner that inconsistent inflation of containers 32 is avoided or at least minimized as a result of a “stop-then-restart” event. In accordance with this embodiment of the invention, controller 94 may thus be configured and programmed to receive a stop command, e.g., from an operator via stop button 92 on control panel 90, and, based on input 182 from tracking sensor 180, send output 102 to web conveyance system 20 to stop conveying the inflatable web 26 such that the web stops at a predetermined location relative to a pair of the transverse seals 38 from adjacent containers, e.g., an un-inflated container 32 adjacent to an inflated container 50.

Using the depiction in FIG. 9 for illustration purposes, one example of a predetermined location at which conveyance system 20 may stop the conveyance of web 26 will be described. Such “predetermined location” may be one in which a pair of transverse seals 38, designated as 38′ for illustration purposes, from adjacent containers, e.g., an un-inflated container 32′ and an inflated container 50′, arrive at and stop in a straddling position relative to sealing device 24. In this manner, the downstream container 50′ associated with the downstream one 38b′ of the pair of transverse seals 38′ is fully inflated and sealed closed, with longitudinal seal 48 intersecting the transverse seal 38b′ to seal closed the downstream/inflated container 50′. On the other hand, the upstream container 32′ associated with the upstream one 38a′ of the pair of transverse seals 38′ is in position to be fully inflated by inflation system 22 and sealed closed by sealing device 24 upon receipt of a restart command, e.g., by the machine operator via start button 91 on control panel 90.

In FIG. 8, transverse seal pair 38′ is making contact with contact sensor 186, and this event is being “reported” to controller 94 via input signal 182 from detection sensor 188. The controller 94 thus “knows” the location of the transverse seal pair 38′, as well as its rate of conveyance between tracking sensor 180 and sealing device 24. Upon receipt of a stop command from stop button 92 (input signal 106 from control panel 90—see FIG. 9), the controller 94 controls (e.g., slows) the rate of conveyance of web 26 via output signal 102/motor 68 such that the web stops just as transverse seal pair 38′ has arrived at the straddling position shown in FIG. 9.

This feature advantageously ensures that the downstream container 50′ is fully inflated and sealed closed, and that the upstream container 32′ is in the correct position to be fully inflated and sealed closed upon a re-start of the machine, so that inconsistent inflation (e.g., under-inflation, over-inflation, or non-inflation) of the containers does not result from stop/re-start episodes.

Sealing device 24 may comprise a pair of convergent members, e.g., a pair of counter-rotating rollers 62, 64, with sealing element 66 secured to at least one of the rollers, e.g., to roller 62 as shown. Alternatively, one convergent member may be rotary while one is stationary. Sealing device 24 may comprise web guides 208, e.g., a pair of such web guides 208a, b, one for sealing roller 62 and one for backing roller 64, respectively, may help direct web 26 away from the seal zone proximal the nip, in a downstream direction along path 40. Sealing device 24 may comprise a deflection device 206 (FIG. 6), which is structured and arranged to intersect with path 40 in such a way that web 26 is deflected and directed against roller 64 as the web is conveyed along path 40, which has the effect of dampening relative movement of sheets 36a, b, smoothing out wrinkles in web 26. The deflection device 206 may comprise a guide bar as shown, or any suitable device capable of deflecting the web onto backing roller 64.

With reference back to FIG. 5, an additional feature of an embodiment of the disclosed subject matter be described. FIG. 5 illustrates one mode of operation, wherein machine 10 may include surface supports, i.e., feet 212, which are adapted to allow the machine to be mounted on a table 214 during operations. A receptacle 216 may be placed adjacent to table 214 as shown, such that completed containers 50 may be directed from machine 10 and into the receptacle, e.g., in order to generate a readily-available supply of the inflated/sealed containers for subsequent use. Machine 10 may thus further include a detector 218 adapted to detect the presence of a predetermined quantity of the inflated containers 50 in receptacle 216, e.g., a height of the inflated containers in the receptacle.

Detector 218 may be in operative communication with controller 94, e.g., via input cable 220, and the controller may be adapted, e.g., programmed, to perform at least one of: a) stopping operation of machine 10 to place it in an idle mode once the predetermined quantity is detected; and b) starting operation of the machine if such predetermined quantity is not detected by placing it in an operative mode. In this manner, a predetermined quantity of inflated containers 50 may be maintained in the receptacle 216. Detector 218 may be an ultrasonic sensor or the like.

Web conveyance system 20 may comprise a pair of rotary members, e.g., rollers 62, 64, wherein at least one of the rotary members is mounted on a pivot mechanism 222 with an actuator and a downstream pivot point 226. The pivot mechanism 222 is movable between: (1) a conveyance position, at which the rotary members/rollers 62, 64 are in contact with one another at nip 65, i.e., the point of convergence between the two rollers (FIG. 1), and (2) a web-threading position (not illustrated), at which the rotary members/rollers 62, 64 are not in contact with one another. In the illustrated embodiment, backing roller 64 is carried on pivot frame 228, which is pivotally mounted on support structure 12 at pivot point 226. Pivot mechanism 222 may be actuated by, for example, pivotally-movable handle member 230, so that backing roller 64 may be moved out of contact with sealing roller 62 to facilitate the placement of web 26 between such rollers, e.g., upon placement of a new roll 28 on spool 18 and subsequent “threading” of the new web 26 through the above-described components of machine 10 along path 40. Once the threading is complete, the pivot mechanism 222 is returned to its conveyance position so that the rollers 62, 64 are in compressive contact with opposing sides of web 26 and ready to begin withdrawing the web from the new roll and advancing the web along path 40.

In reference to FIGS. 10 to 17, a system 310 for providing inflated containers 50 from a web 26 of inflatable containers is described. The system includes web conveyance system 20, which has been previously described herein in association with machine 10. The conveyance system 20 has an operative mode in which the web 26 is advanced along the path of travel 40 by counter-rotating members 62, 64 having nip 65 through which at least a portion of the web 26 passes. Conveyance system 20 also has a idle mode in which the web is stationary. The system 310 also includes an inflation nozzle 82, which has been previously described herein in association with machine 10.

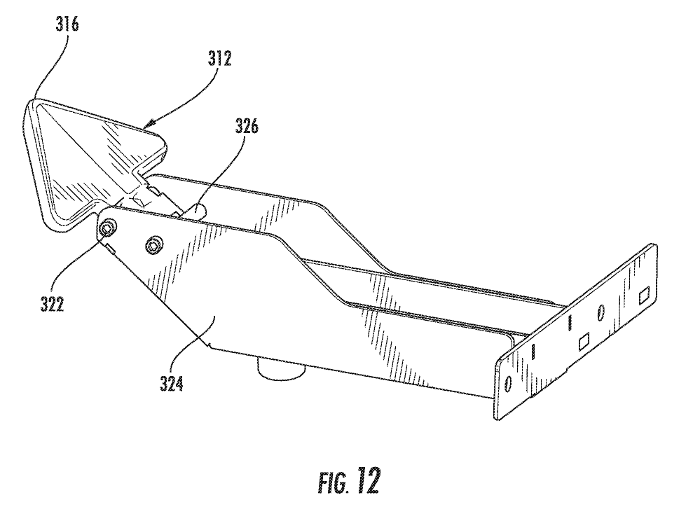

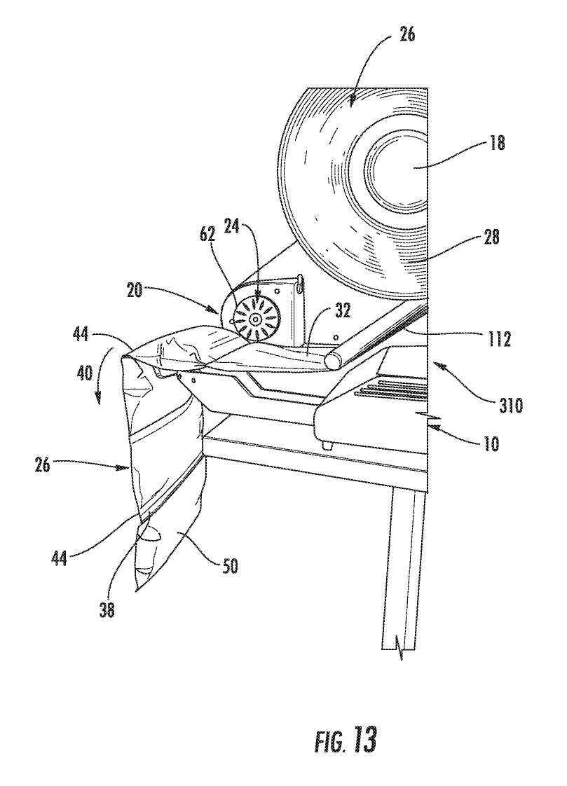

System 310 includes a detachment arm 312 positioned beside the path of travel 40 of the web 26 and downstream from the inflation nozzle 82. Detachment arm 312 includes a separation end 316 to engage the web in the path of travel. The detachment arm 312 also includes a body portion 320 that may be pivotally mounted to bracket 324 by pivot point 322. Bracket 324 may in turn be mounted to support structure 12 of machine 10 so that the detachment arm is attached to the support structure, to which the conveyance system 20 is also attached. Bracket 324 may be adjustable in length (e.g., telescoping) so that the position of the detachment arm 312 beside the path of travel 40 is adjustable along the path of travel. For example, the bracket 324 has a relatively short first position (FIGS. 10 and 12) in which the bracket is collapsed to accommodate relatively short inflated containers and a relatively long second position (FIG. 11) in which the bracket is extended to accommodate relatively long inflated containers. Accordingly, the position of the detachment arm 312 beside the path of travel 40 may be adjustable along the path of travel to a desired operating position determined by the length of the containers of the web.

As an alternative configuration, although the conveyance system 20 may be attached to support structure 12, the detachment arm 312 may not be attached to the same support structure, so that the detachment arm is removed, distanced, or spaced from machine 10, but may nevertheless still be positioned beside the path of travel 40 of the conveyed web 26. For example, detachment arm 312 may be on one end of a table and machine 10 on the opposite end of the table.

The separator end 316 of detachment arm 312 may be adapted to separate the web 26 along the transverse detachment line 44 as a detachment force is applied to the web while the separator end 316 of the detachment arm is aligned with the transverse detachment line 44. For example, the separator end 316 may have a shape that facilitates the tearing of the web along the transverse detachment line by provided a focal region for a detachment force applied to the web (e.g., a manual pulling force) against the separator end. For example, the separator end 316 may have a triangular or arrowhead shape having the apex pointing toward the path of travel, as illustrated in FIGS. 10 to 17. A detachment force is the force applied (e.g., by pulling the web) to tear or separate the web along the transverse detachment line.

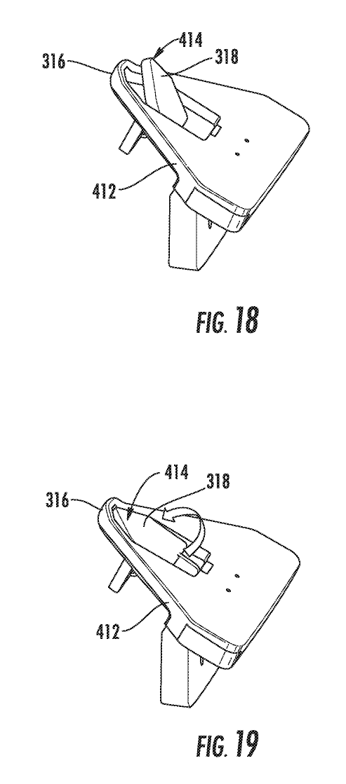

The system may include a receptor 314 adapted to detect whether a detachment event occurs at (e.g., a detachment force is applied by) the separator end 316 such that the web is detached at a transverse detachment line 44 and to transmit a detachment signal in response to the detachment event that resulted from the application of the detachment force. For example, FIG. 16 shows receptor 314 in the form of an optical switch that is in the “off” or interrupted mode when the detachment arm is in a normal position such that the body portion 320 blocks or interrupts the switch by a biased downward pivot around pivot point 322. This indicates that a detachment event has not occurred because a detachment force is not being applied by the separator end 316 of the detachment arm. A signal may be sent to controller 94 to provide this indication (i.e., a non-detachment signal) or if alternatively programmed, the lack of a signal to controller 94 may provide this indication.

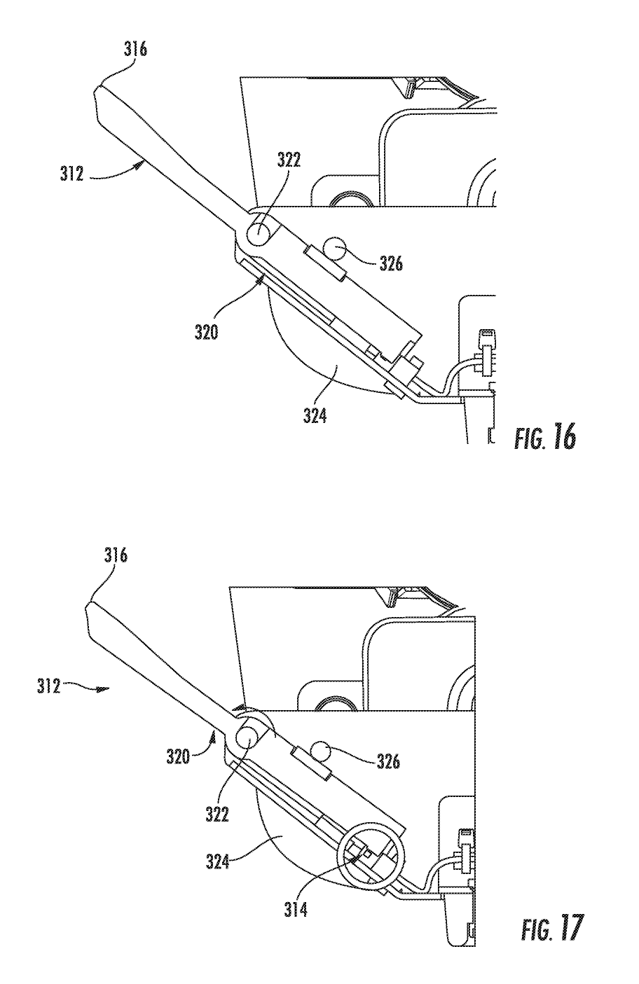

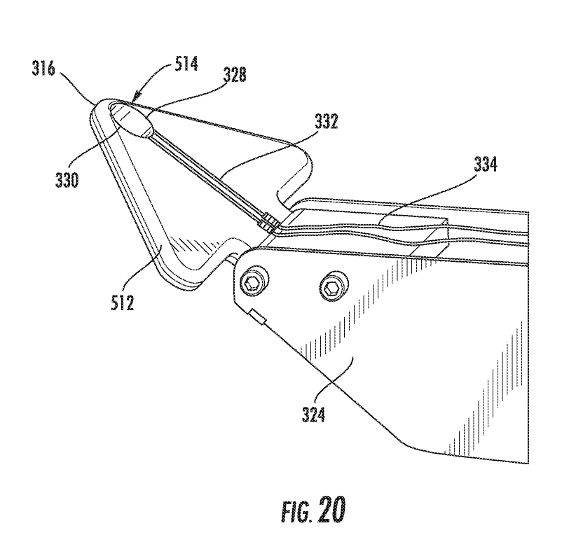

If a detachment event occurs (e.g., a detachment force is applied by separator end 316 in the form of a pull on the web 26 of inflated cushions hanging over the separator end to detach the web along a transverse detachment line), then the detachment arm 312 pivots about pivot point 322 until the pivot movement is halted by stop 326 so that the detachment arm is in a detachment position in which the force applied to the separator end 316 is resisted to detach the web along the transverse detachment line 44 of the web. (See, e.g., FIGS. 15 and 17.) In this detachment position, the body portion 320 of the detachment arm no longer blocks the receptor 314 optical switch so that the switch is in the “on” or uninterrupted mode to indicate that a detachment event has occurred because of the detachment force applied by the separator end 316 of the detachment arm. (FIG. 17.) The receptor may send a corresponding signal (i.e., a detachment signal) to controller 94 to provide this information in response to the detachment event (or if alternatively programmed, the lack of a signal to controller 94 may provide this detachment signal).

In this manner in the embodiment of FIGS. 10 to 17, the detachment arm 312 is moveable between a detachment position (FIG. 17) and a normal position (FIG. 16). In the detachment position the separator end 316 resists a detachment force by the separator end 316 (e.g., by a pull on a web hanging over the separator end as illustrated in FIG. 15) and the detachment arm 312 engages the receptor 314 (e.g., by no longer blocking or interrupting the optical signal of the switch) to send a detachment signal to the controller 94 that a detachment event has occurred. In the normal position, the detachment arm 312 is biased away from the detachment position. This bias of the detachment arm to the normal position is strong enough to stay in the normal position even as an inflated container 50 of web 26 may rest on or cross the detachment arm. However, a detachment force is applied by the separator end 316, for example by pulling downwardly on web 26 positioned across the separator end 316, overcomes this bias to the normal position.

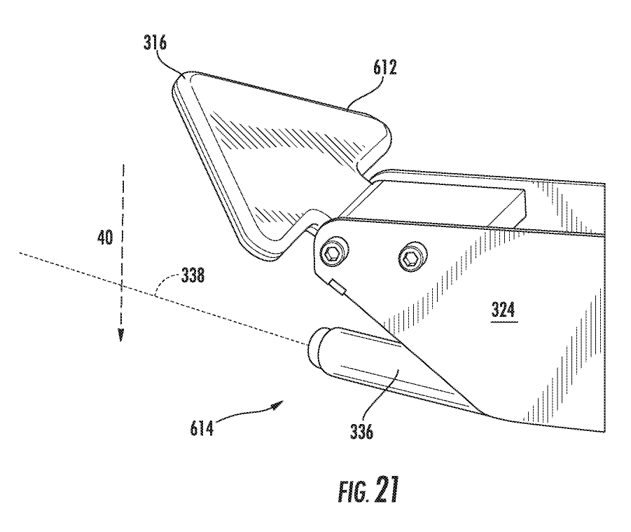

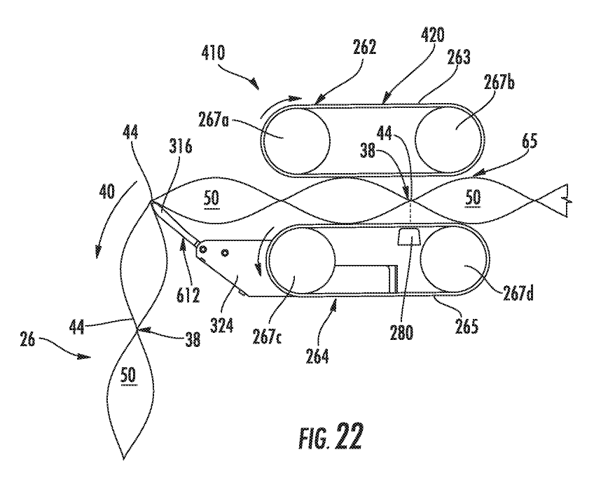

Another exemplary embodiment for the detachment arm and receptor is illustrated in FIGS. 18 to 19. In this embodiment, the detachment arm 412 may be mounted or installed to be stationary during a detachment event (e.g., not moveable in providing a detachment signal). Detachment arm 412 has separator end 316. Receptor 414 includes flapper switch 318. As mentioned above, a receptor is adapted to detect whether a detachment event has occurred at the separator end 316 and to transmit a detachment signal in response to the occurrence of the detachment event. In this embodiment, flapper switch 318 of receptor 414 is moveably mounted integrally within the detachment arm 412. The flapper switch 318 is mounted proximal the separation end 316 to facilitate detection of a detachment force applied by the separation end. The flapper switch 318 is moveable between (i) a triggered position (FIG. 19) in which a detachment force applied by the separator end causes the flapper switch to transmit a detachment signal to indicate that a detachment event has occurred and (ii) a normal position (FIG. 18) in which the detachment switch is biased away from the triggered position. The bias of the flapper switch to the normal position is strong enough to stay in the normal position even as an inflated container 50 of web 26 may rest on or cross the flapper switch. However, if a detachment force is applied by the separator end 316, for example by pulling downwardly on web 26 positioned across the separator end 316 so that the separator end 316 engages the transverse detachment line 44 of the web to detach a string of inflated containers from the web, then the downward pull force also moves the web to move flapper switch 318 from the biased normal position to the triggered position (which, e.g., in this illustration “lays flat” with the surface of the detachment arm) to signal that a detachment event has occurred.

The receptor 414 comprising flapper switch 318 may send a detachment signal (for example to controller 94) to indicate that a detachment event has occurred resulting from the application of a detachment force by the separator end 316 of the detachment arm when the flapper switch is in the triggered position. Also, if alternatively programmed such that a normal signal is provided to controller 94 when the flapper switch is in the normal position, then the detachment signal may be provided by the lack or interruption of the normal signal to controller 94.

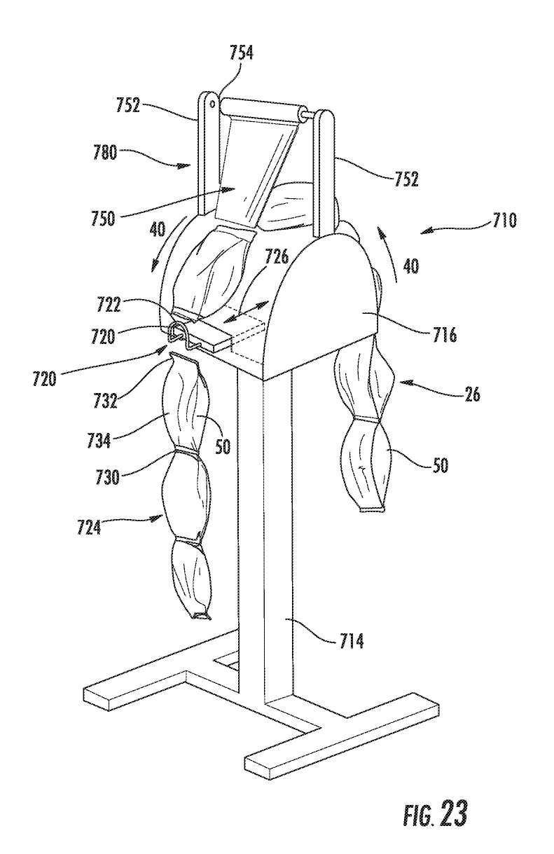

Another exemplary embodiment for the detachment arm and receptor is illustrated in FIG. 20. In this embodiment, the detachment arm 512 may be mounted or installed to be stationary during a detachment event, for example, mounted to bracket 324. Detachment arm 512 has separator end 316. Receptor 514 includes force-sensitive resistor (FSR) 328 having active area 330 mounted proximal the separator end 316 of the detachment arm 512 to facilitate detection of a detachment force applied to the separation end. FSR 328 includes a tail 332 to which leads 334 may be attached for transmitting a signal to, for example, controller 94. Although this embodiment is described in terms of an FSR, other devices for providing a signal in response to a pressure of force may be used, such as a strain gauge, flexion sensor, bend sensor, and the like. If a detachment event occurs by a detachment force applied by separator end 316, for example by pulling downwardly on web 26 positioned across the separator end 316 so that the separator end 316 engages the transverse detachment line 44 of the web to detach a string of inflated containers from the web, then the downward pull force also moves the web to engage or apply force to the active area 330 of FSR 328. In response, the FSR sends a signal (i.e., a detachment signal) though the tail 332 and lead 334 to, for example, controller 94 to indicate that a detachment event has occurred.

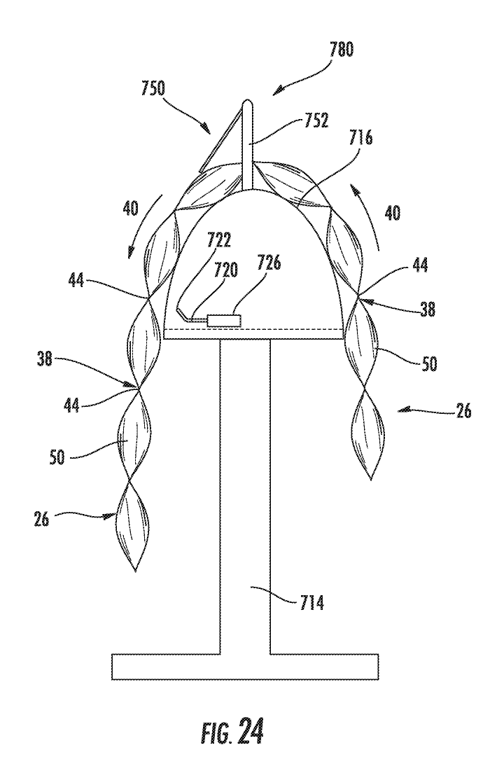

Still another exemplary embodiment for the detachment arm and receptor is illustrated in FIG. 21. In this embodiment, the detachment arm 612 may be mounted or installed to be stationary during a detachment event, for example, mounted to bracket 324. Detachment arm 612 has separator end 316. Receptor 614 includes detector 336 such as an optical sensor (e.g., an electro-optical sensor) or an ultrasonic sensor (e.g., ultrasonic transducer). The detector 336 is pointed to sense along target line 338, which intersects the path of travel 40 for the web 26. If a detachment event occurs by a detachment force applied by separator end 316, for example by pulling downwardly on web 26 positioned across the separator end 316 along the path of travel 40 so that the separator end 316 engages the transverse detachment line 44 of the web to detach a string of inflated containers from the web, then a gap is created by the detachment of the web such that the detector senses the space caused by the detachment event. In response, the detector 336 sends a signal (i.e., a detachment signal), for example, controller 94 to indicate that a detachment event has occurred.

FIG. 22 illustrates an embodiment of the disclosed subject matter in which web conveyance system 420 includes opposing counter-rotating rotary members 262, 264 that form a nip 65 through which web 26 of inflated containers 50 passes to advance along the path of travel 40. As illustrated, counter-rotating rotary member 262 is in the form of a conveyor belt 263 traveling about head pulley 267a, which provides the driving motion to the belt, and a tail pulley 267b. Similarly, as illustrated, counter-rotating rotary member 264 is in the form of a conveyor belt 265 traveling about head pulley 267c, which provides the driving motion to the belt, and a tail pulley 267d. The conveyance system (e.g., web conveyance system 420) has (i) an operative mode in which the web 26 is advanced along the path of travel 40 by counter-rotating members having a nip through which at least a portion of the web passes and (ii) an idle mode in which the web 26 is stationary. The web conveyance system 420 may be operatively controlled, for example, by controller 94 (not shown in FIG. 22). The source of the web 26 of inflated containers 50 may be directly from a machine, such as machine 10 for inflating and sealing an inflatable web as described herein, or may be from an accumulation of a web of cushions, for example, from a storage container or bin.

Transverse tracking sensor 280 is positioned to detect location information for the transverse detachment lines 44 of the web 26. Transverse tracking sensor 280 may include one or more of the sensors described herein, for example, a mechanical sensor (i.e., using physical contact), an optical sensor, an ultrasonic sensor, a magnetic sensor, a force sensor (e.g., a force-sensitive resistor and the like), and an accelerometer. The transverse tracking sensor may detect a transverse detachment line 44, or may detect a transverse seal 38, the locating of the one will provide location information of the other as previously discussed herein. Such location information may be provided to a controller 94 (not shown in FIG. 22), as described herein. Additionally or alternatively, the sensor 280 may operate or function as a counter to detect and count the passing of each container 50 of the web 26 along the path of travel 40 and to transmit this counter information, for example, to controller 94.

Continuing with FIG. 22, detachment arm 612 is positioned beside the path of travel 40 and downstream from the web conveyance system 420 and/or the sensor 280. The detachment arm 612 may be mounted or installed to be stationary during a detachment event, for example, mounted to bracket 324. Detachment arm 612 has separator end 316. Although illustrated with detection arm 612, this embodiment may alternatively incorporate any of the detachment arms discussed herein, as well as any of the receptors described herein for use in combination with such detachment arms.

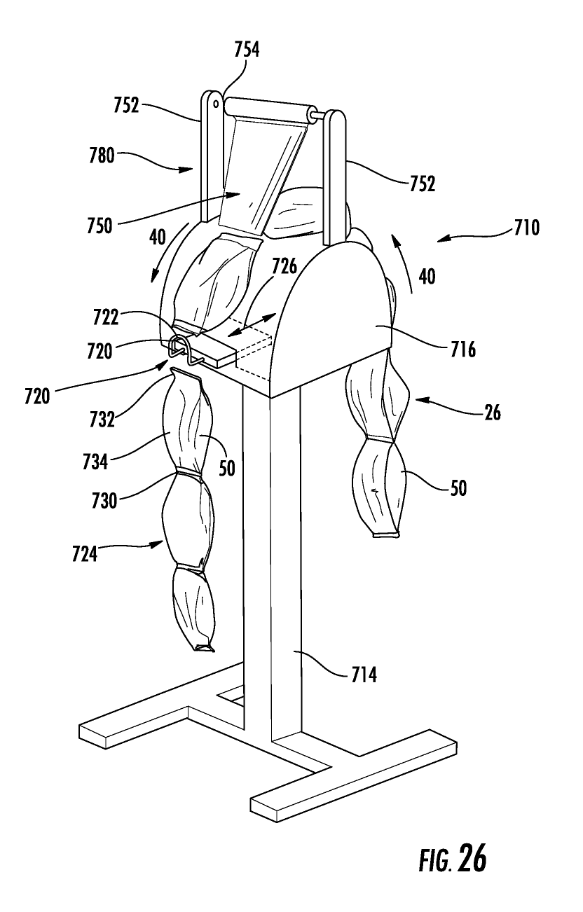

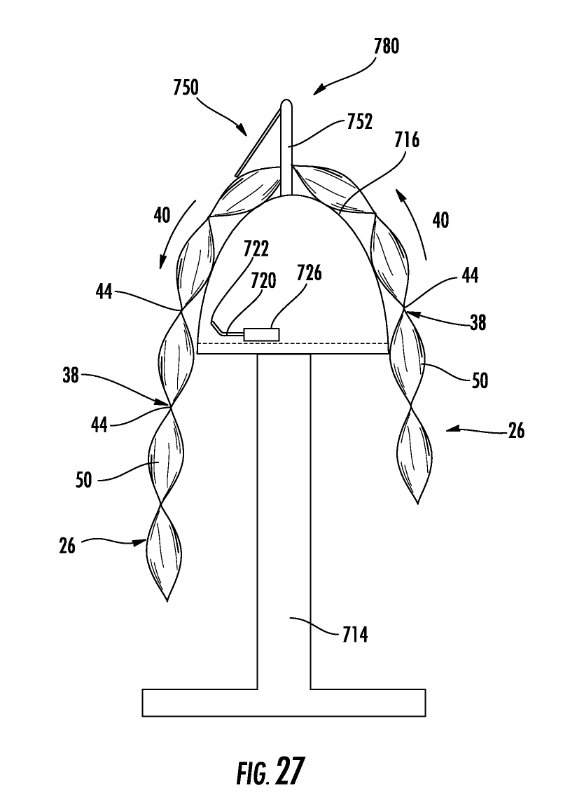

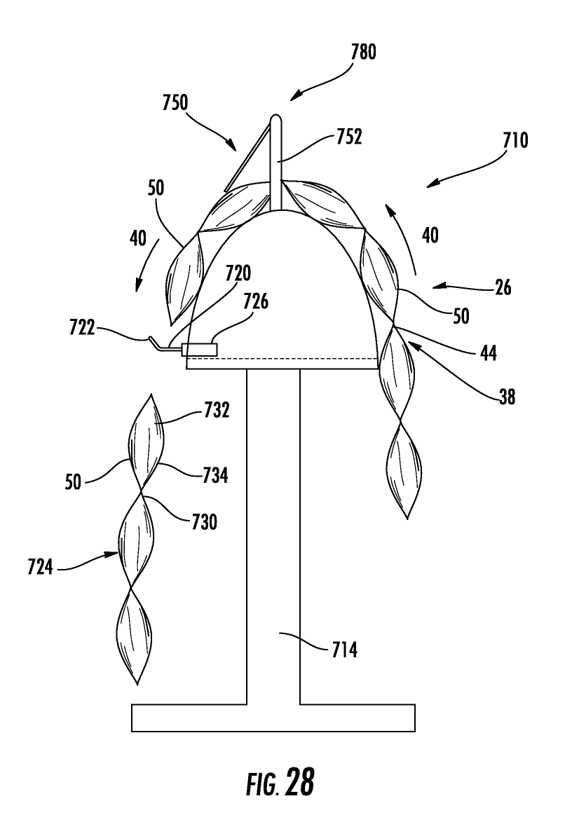

FIGS. 23 to 25 illustrate an embodiment of the disclosed subject matter in which machine 710 is adapted to separate a web 26 of inflated containers 50. The source of the web 26 of inflated containers 50 may be directly from a machine, such as machine 10 for inflating and sealing an inflatable web as described herein, or may be from an accumulation of a web of cushions, for example, from a storage container or bin (not illustrated). The machine 710 includes a base 714 supporting platform 716 arranged to support the web 26 of cushions that may be drawn across the platform along path of travel 40. Counter 780 is positioned beside or along the path of travel 40 and includes sensor 750. Sensor 750 is adapted to operate as a mechanical sensor to detect the passing of each container 50 of the web 26 as it moves by the sensor to contact the sensor. Sensor 750 transmits the resulting counter information (e.g., the number of containers that has passed over a given period) based on the passing, for example, to controller 94 (not shown). Sensor 750 of the counter 780 is supported by a pair of columns 752, which in turn support beam 754. Sensor 750 is rotatably supported by beam 754 so that sensor 750 may move (e.g., swing) as a cushion 50 passes. Although machine 710 is illustrated with sensor 750, any of one or more of the sensors described herein may be utilized for this function, for example, an optical sensor, an ultrasonic sensor, a magnetic sensor, a force sensor, and an accelerometer. The sensor of counter 780 may also be adapted to detect a transverse detachment line 44, or may detect a transverse seal 38. Detachment arm 720 is positioned beside the path of travel 40 and has separator end 722 adapted to engage the web in the path of travel to detach a string of cushions 724. The detachment arm 720 is moveable between: (i) an engaged position (FIGS. 23 and 25) in which the separator end 722 is aligned with a transverse detachment line 44 of the web in the path of travel 40 and (ii) a disengaged position (FIG. 24) in which the separator end 722 does not engage the web 26 in the path of travel 40. Detachment arm 720 may be attached to actuator 726 to effect the movement of the detachment arm between the engaged and disengaged positions. Controller 94 (not shown) may be in operative control of actuator 726. The operation of machine 710 will be described below.

### Operation

The operation of the systems described herein have some similarities in that a controller, such as controller 94, may be used to control, monitor, initiate, and/or stop the various operations of the systems and machines. Controller 94 has been previously described above in some aspects. The controller may be programmed to receive, process, and react to any of the signals described herein.

For example, controller 94 may be programmed with a predetermined number of containers that is desired or identified for the string of cushions for a particular packaging need. The predetermined number of cushions may be entered via an operator interface with the controller 94, or may be received by controller 94 through other electronic communication. In some situations, the predetermined number of containers for the string of cushions will not vary often, for example, when the packaging need is similar for numerous packages. In that case, the programmed predetermined number of cushions will stay the same until changed. In other situations, the controller 94 may receive information for the predetermined number of containers (for the string of cushions) for individual packaging, for example from a warehouse management system or from scanned information from a product code, in which case the predetermined number of cushions may vary with each product to be packaged. The information for the predetermined number of containers may be provided or calculated in the form of a length of web material that corresponds with the desired number of containers if the length of the containers is known.

Controller 94 may be programmed to receive a detachment signal and to operatively control the web conveyance system (e.g., systems 20, 420) to move the conveyance system to its operative mode to advance the web by the predetermined number of containers if the detachment signal is received while the conveyance system is in the idle mode. Further, the controller 94 may also be programmed to move the conveyance system (20, 420) to the idle mode to stop the advancement of the web 26 after the completing the predetermined number of containers if a detachment signal is not received during the advancement of the predetermined number of containers. Also, the controller may be programmed to continue to advance the web 26 if a detachment signal is received while the conveyance system is in the operative mode.

Under this programming arrangement, an operator may pull on the web 26 of inflated containers (for example, web 26 of FIG. 15) to create a detachment event by detaching a string of inflated cushions from the web 26 along the transverse detachment line 44. This causes a detachment signal to be sent to the controller 94, which (if the conveyance system is in the idle mode) moves the conveyance system to the operative mode so that the predetermined number of cushions will be made. If the operator has not pulled on the web 26 while the predetermined number of containers is being advanced, then the controller will return the conveyance system to the idle mode after completion of the predetermined number of containers, so that the predetermined number of containers will be immediately ready for when the operator next desires to detach the string of cushions from the web.

However, if the operator pulls on the web 26 while the predetermined number of containers is being advanced, then an additional detachment signal is sent to and received by the controller (even though an actual detachment has not occurred), and the controller continues to instruct the conveyance system to advance the web until a detachment signal is not received during the advancement of the predetermined number of containers, in which case the controller moves the conveyance system to the idle mode.

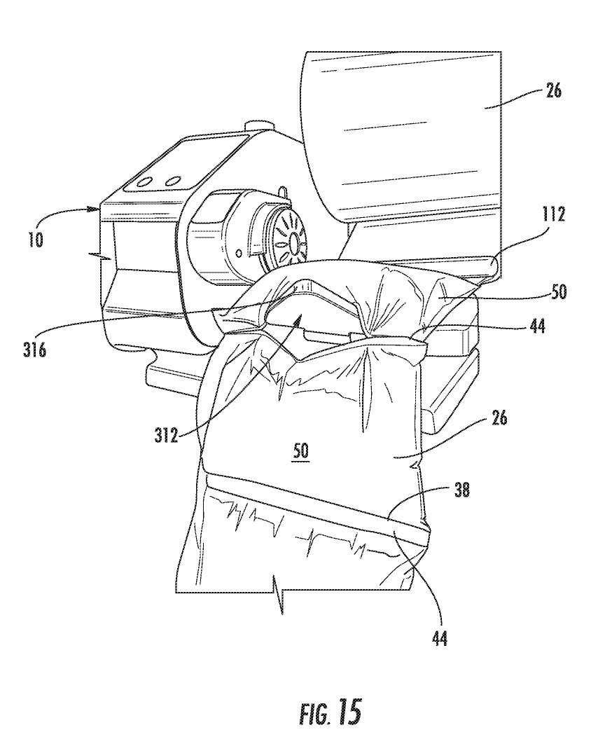

Controller 94 may be programmed to receive the location information for the transverse detachment lines 44 from the transverse tracking sensor (180, 280) and to move the conveyance system (20, 420) to the idle mode so that a transverse detachment line 44 is aligned with the separator end 316 of any of the detachment arms described herein. To achieve this, the controller may be programmed to have information regarding one or more of (i) the distance from the transverse tracking sensor to the separator end 316, (ii) the length between the transverse detachment lines 44 (i.e., the length of the containers), (iii) the speed of the advancement of the web 26, (iv) the distance that the web advances relative the rotation of the counter-rotating members (e.g., 62, 64) of the conveyance system, and (v) the number of rotations of the counter-rotating members. A transverse detachment line 44 is aligned with the separator end 316 when a detachment force applied to the web (e.g., a pull) causes the separation end to engage the transverse detachment line 44 to cause a detachment event. “Alignment” in this sense does not have to be exact. FIGS. 14, 15, and 22 illustrate an alignment.

The controller 94 may be programmed to operatively control the conveyance system (e.g., conveyance system 420 of FIG. 22) to advance the web by the predetermined number of containers in response to an advancement signal received by the controller. An advancement signal may be provided by a warehouse management system that sends to the controller the advancement signal. The warehouse management system may also send to the controller information for the predetermined number of containers, for example, associated with a product to be packaged. Controller 94 may be is in communication with a scanner that provides the advancement signal to the controller in communication with the scanner. Also, the controller may be in communication with a switch (e.g., foot-activated or hand-activated) to provide the advancement signal to the controller.

The machine 710 illustrated in FIGS. 23 to 25 may be operated as follows. Controller 94 may be programmed to receive the counter information and/or location information that may be provided by sensor 750 of counter 780. Controller 94 may also be programmed with a predetermined number of containers information, as discussed above in connection with other embodiments. The controller 94 may also be programmed to operatively control the position of detachment arm 720 by operatively controlling the actuator 726. Controller 94 may be programmed to operatively control the movement of the detachment arm in response to the counter information and the predetermined number of containers information.

An operator may manually pull on the web 26 of cushions 50 to move the web across the platform. As the predetermined number of containers has passed counter 780, the controller 94 moves the detachment arm 720 to the engaged position so that the operator may apply a detachment force to the web so that the transverse detachment line 44 engages the separator end 722 to separate the string of cushions 724 from the web 26 along the transverse detachment line. Advantageously, the operator may be able to perform this detachment event with one hand. Further, the operator does not have to count the number of containers because as the predetermined number has been reached, the detachment arm is engaged so that the operator may detach a string of cushions having the desired, predetermined number of cushions.

In one aspect of this embodiment, the detachment arm 720 may move to the engaged position while the operator is manually pulling the web. Each container of the web is between a leading transverse detachment line and a trailing transverse detachment line relative the container and the path of travel. The controller may be programmed to identify the leading transverse detachment line (e.g., line 730) of the last container (e.g., container 734) of the predetermined number of containers and to move the detachment arm toward the engaged position after the leading transverse detachment line of the last container of the predetermined number of containers has passed the detachment arm 720, in order to place the detachment arm in the engaged position (FIG. 23) for the trailing transverse detachment line (e.g., line 732) of the last container of the predetermined number of containers. In this manner, the detachment arm moves into place so that it can be in the engaged position so that the pulling force on the web is translated to a detachment force as the trailing transverse detachment line (e.g., line 732) aligns with the separator end 722. This arrangement allows the operator to pull the web so that the detachment arm engages at the appropriate time to avoid detaching the web at the wrong transverse detachment line.

To this end, the controller may be programmed to receive the predetermined number of containers information and compare this to the information gained by counting the containers. The controller can then identify the last container for the predetermined number of containers. The controller may determine when the leading transverse detachment line will have passed the detachment arm, for example, by comparing the speed with which the web is moving to the distance for the location of the detachment arm, or by allowing a determined or given amount of time to pass. The controller may then actuate the detachment arm to move after the leading transverse detachment line has passed.

The controller may instruct the separator arm to retract to the disengaged position after a set period of time. If the machine 710 includes one of the receptors described herein (not illustrated), then the receptor may detect a detachment event for which a detachment signal is transmitted to controller 94, which then instructs the detachment arm to retract to the disengaged position.

In another aspect of this embodiment, the counter 780 may also function as the detachment arm 720, for example, to lock in place after the predetermined number of containers has passed so that the operator may manually apply the detachment force to cause the detachment event.

The above descriptions are those of preferred embodiments of the invention. Various alterations and changes can be made without departing from the spirit and broader aspects of the invention as defined in the claims, which are to be interpreted in accordance with the principles of patent law, including the doctrine of equivalents. Any reference to an item in the disclosure or to an element in the claim in the singular using the articles “a,” “an,” “the,” or “said” is not to be construed as limiting the item or element to the singular unless expressly so stated. The definitions and disclosures set forth in the present Application control over any inconsistent definitions and disclosures that may exist in an incorporated reference.

What is claimed is:

1. A system for providing a web of inflated containers, the web having a transverse detachment line between the adjacent containers, the system comprising:
a conveyance system having:
an operative mode in which the web is advanced along a path of travel by counter-rotating members having a nip through which at least a portion of the web passes; and
an idle mode in which the web is stationary;
a detachment arm positioned beside the path of travel downstream from the conveyance system, the detachment arm having a separator end to engage the web in the path of travel; and
a controller programmed to operatively control the conveyance system to move to: (i) the operative mode to advance the web by a predetermined number of containers and (ii) the idle mode in which a transverse detachment line of the web is aligned with the separator end of the detachment arm.

2. The system of claim 1 further comprising a transverse tracking sensor adapted to detect location information for the transverse detachment lines of the web and provide the location information to the controller.

3. The system of claim 2 wherein the transverse tracking sensor comprises one or more of an optical sensor, a mechanical sensor, a magnetic sensor, a force-sensitive resistor, a strain gauge, and an accelerometer.

4. The system of claim 1 wherein the separator end is adapted to separate the web along the transverse detachment line as a detachment force is applied to the web while the separator end is aligned with the transverse detachment line.

5. The system of claim 4 wherein the separator end of the detachment arm has a triangular shape having an apex pointing toward the path of travel.

6. The system of claim 1 wherein the position of the detachment arm beside the path of travel is adjustable along the path of travel.

7. The system of claim 1 wherein the controller is programmed to operatively control the conveyance system to advance the web by a predetermined number of containers in response to an advancement signal received by the controller.

8. The system of claim 7 wherein the controller is in communication with a warehouse management system configured to send to the controller the advancement signal.

9. The system of claim 8 wherein the controller is in communication with a warehouse management system configured to send to the controller information for the predetermined number of containers associated with a product to be packaged.

10. The system of claim 7 wherein the controller is in communication with a scanner configured to provide the advancement signal.

11. The system of claim 7 wherein the controller is in communication with a manually-activated switch configured to provide the advancement signal.

12. The system of claim 1 further comprising a receptor adapted to detect whether a detachment event occurs at the separator end and transmit a detachment signal in response to the detachment event, wherein the controller is programmed to receive the detachment signal and to operatively control the conveyance system to move the conveyance system to the operative mode to advance the web by a predetermined number of containers if the detachment signal is received while the conveyance system is in the idle mode.

13. The system of claim 12 wherein the controller is programmed to move the conveyance system to the idle mode to stop the advancement of the web after the completing the predetermined number of containers if a detachment signal is not received during the advancement of the predetermined number of containers.

14. The system of claim 13 wherein the controller is programmed to continue to advance the web if a detachment signal is received while the conveyance system is in the operative mode.

15. The system of claim 12 wherein the receptor comprises a device adapted to detect the detachment event, the device comprising one or more of an optical sensor, an ultrasonic sensor, a force-sensitive resistor, a strain gauge, a flexion sensor, and a bend sensor.

16. The system of claim 12 wherein the receptor comprises a flapper switch moveable between:
a triggered position, in which a detachment force applied by the separator end causes the flapper switch to transmit the detachment signal; and
a normal position, in which the flapper switch is biased away from the triggered position.

17. The system of claim 16 wherein the flapper switch is integral with the detachment arm.

18. The system of claim 12 wherein the detachment arm is moveable between:
a detachment position, in which the separator end resists the detachment force and the detachment arm engages the receptor to send the detachment signal; and
a normal position, in which the detachment arm is biased away from the detachment position.

19. A machine for separating a web of inflated containers, the web having a transverse detachment line between the adjacent containers, the machine comprising:
a counter comprising a sensor to detect the passing of each container of the web along a path of travel and to transmit counter information based on the passing;
a detachment arm positioned beside the path of travel downstream from the counter, the detachment arm having a separator end to engage the web in the path of travel, the detachment arm being moveable between:
an engaged position in which the separator end is aligned with a transverse detachment line of the web in the path of travel; and
a disengaged position in which the separator end does not engage the web; and
a controller programmed to receive the counter information and a predetermined number of containers information to operatively control the movement of the detachment arm in response to the counter information and the predetermined number of containers information.

20. The machine of claim 19 wherein:
each container of the web is between a leading transverse detachment line and a trailing transverse detachment line; and
the controller is programmed to identify the leading transverse detachment line of the last container of the predetermined number of containers and to move the detachment arm toward the engaged position after the leading transverse detachment line of the last container of the predetermined number of containers has passed the detachment arm to place the detachment arm in the engaged position for the trailing transverse detachment line of the last container of the predetermined number of containers.
